(19) United States
(12) Patent Application Publication
(10) Pub. No.: US 2026/0289765 A1
(43) Pub. Date: Sep. 24, 2026

(54) IMAGE-BASED TRANSPARENT OBJECT DEFECT DETECTION

(71) Applicant: Align Technology, Inc., San Jose, CA (US)

(72) Inventors: Anna Kashtanova, Morrisville, NC (US); Dmitry Ustinin, Yerevan (AM); Mikhail Roshchin, Madrid (ES); Aleksandr Levkovich, Yerevan (AM); Roman Belyy, Yerevan (AM); Gleb Milyukov, Madrid (ES)

(21) Appl. No.: 19/543,824

(22) Filed: Feb. 18, 2026

Related U.S. Application Data
(60) Provisional application No. 63/776,962, filed on Mar. 24, 2025.

(51) Int. Cl. G06T 7/00; G01N 21/958; G06T 7/11; G06T 7/12; G06T 7/73; G06V 10/25; H04N 23/74; H04N 23/90; G06V 10/82; H04N 25/131

(52) U.S. Cl. CPC G06T 7/001; G01N 21/958; G06T 7/11; G06T 7/12; G06T 7/73; G06V 10/25; H04N 23/74; H04N 23/90; G06T 2207/10048; G06T 2207/20081; G06T 2207/20084; G06T 2207/20132; G06T 2207/30144; G06V 10/82; G06V 2201/06; H04N 25/131

(57) ABSTRACT

A defect detection system of transparent three-dimensional (3D) objects comprises a transparent platform configured to support a transparent 3D object, a plurality of light sources disposed beneath the transparent platform to illuminate the transparent 3D object through the transparent platform, a plurality of cameras, and a computing device. The plurality of cameras are disposed about the transparent platform above a plane of the transparent platform and angled relative to the transparent platform, and are configured to generate a plurality of images of the transparent 3D object from a plurality of directions while the transparent 3D object is illuminated by one or more of the plurality of light sources. The computing device is configured to process the plurality of images to determine whether the transparent 3D object comprises a defect, and to output an indication of whether the transparent 3D object comprises a defect.

### RELATED APPLICATIONS

This patent application claims the benefit under 35 U.S.C. §119(e) of U.S. Provisional Application No. 63/776,962, filed Mar. 24, 2025, which is incorporated by reference herein.

### TECHNICAL FIELD

The present disclosure relates to the field of manufacturing transparent products and, in particular, to detecting defects in or on transparent (3D) printed products.

### BACKGROUND

Image-based defect detection is problematic for transparent objects because it is difficult to effectively image transparent objects. Without high quality images of transparent objects to assess, any defect detection performed on the transparent objects is inaccurate.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1A illustrates a perspective view of one embodiment of an image based quality control system that performs automated defect detection of transparent three-dimensional (3D) objects, in accordance with embodiments of the present disclosure.

FIG. 1B illustrates a side view of the image based quality control system of FIG. 1A, in accordance with embodiments of the present disclosure.

FIG. 2A is an optical diagram of an image based quality control system, in accordance with embodiments of the present disclosure.

FIG. 2B is a diagram of a side view camera, in accordance with embodiments of the present disclosure.

FIG. 3 illustrates a lighting assembly for a side light of an image based quality control system, in accordance with embodiments of the present disclosure.

FIG. 4 is a rays propagation diagram for an image based quality control system, in accordance with embodiments of the present disclosure.

FIG. 5A is an example image captured by a top view camera of an image based quality control system, in accordance with embodiments of the present disclosure.

FIGS. 5B - E are an example images captured by different side view cameras of an image based quality control system, in accordance with embodiments of the present disclosure.

FIG. 6 illustrates a flow diagram for a method of performing defect detection for a transparent 3D object, in accordance with embodiments of the present disclosure.

FIG. 7 illustrates a flow diagram for a method of determining an identification of a transparent 3D object, in accordance with embodiments of the present disclosure.

FIG. 8 illustrates a flow diagram for a method of processing an image captured by an imaging system to detect a defect in a transparent 3D object, in accordance with embodiments of the present disclosure.

FIG. 9 illustrates a flow diagram for a method of processing an image captured by an imaging system to detect a defect in a transparent 3D object, in accordance with embodiments of the present disclosure.

FIG. 10 illustrates a block diagram of an example computing device, in accordance with embodiments of the present disclosure.

FIG. 11 illustrates a tooth repositioning appliance, in accordance with embodiments of the present disclosure.

FIG. 12 illustrates a tooth repositioning system, in accordance with embodiments of the present disclosure.

FIG. 13 illustrates a method of orthodontic treatment using a plurality of appliances, in accordance with embodiments of the present disclosure.

FIG. 14 illustrates a method for designing an orthodontic appliance to be produced by direct fabrication, in accordance with embodiments of the present disclosure.

FIG. 15 illustrates a method for digitally planning an orthodontic treatment, in accordance with embodiments of the present disclosure.

### DETAILED DESCRIPTION OF THE DRAWINGS

Described herein are embodiments covering systems, methods, and/or computer-readable media suitable for image based quality control (IBQC) of transparent custom manufactured products. The transparent custom manufactured products may be customized medical devices. For example, in some embodiments, the image based quality control systems and methods may be implemented in the inspection of transparent orthodontic aligners after manufacturing. Quality control of transparent custom manufactured products is particularly difficult, especially in orthodontic aligner manufacturing where orthodontic aligners must be individually customized for every single patient. Additionally, each aligner in the series of aligners used to treat a single patient is unique compared to other aligners in the same series because each aligner is specific to different stages of treatment. Each patient receives a pair of aligners for each stage of treatment, one unique aligner for treating the upper arch and one unique aligner for treating the lower arch. In some instances, a single treatment can include 50-60 stages for treating a complex case, meaning 100-120 uniquely manufactured aligners for a single patient. It is particularly difficult to capture high quality images of transparent objects for automated image based quality control, which reduces the accuracy of such IBCQ systems when used with transparent 3D objects.

When manufacturing aligners for patients worldwide, the manufacturing of several hundred thousand completely unique and customized aligners per day may be needed. As such, quality control of the custom manufactured products can be a particularly daunting task. Quality control of manufactured aligners may be performed to ensure that the aligners are defect free or that defects are within tolerable thresholds. The quality control process may be aimed at detecting one or more of the following quality issues: arch variation, bend, cutline variation, debris, webbing, trimmed attachments, missing attachments, burrs, flaring, power ridge issues, material breakage, short hooks, bubbles, and so forth. Additionally, some transparent 3D objects may be 3D printed objects. In such cases, additional types of defects may occur. Examples of additional defects that may be encountered for transparent 3D printed objects include surface defects, internal volume defects, interface defects, and layering defects. For example, a gap may exist between one or more thin layers of transparent 3D object as a result of the manufacturing process, causing air to become trapped within that gap. This type of defect is referred to herein as an "internal volume defect." In another example, particles (e.g., debris), may form or collect on the surface of the transparent 3D object. This type of defect is referred to herein as a “surface defect.” In a further example, holes (e.g., pits) may form at the interface of the internal volume and the surface of the transparent 3D object. This type of defect is referred to herein as an “interface defect.” Internal volume defects, surface defects, interface defects, and other defects caused during manufacturing (e.g., during fabrication of 3D printed objects) may be referred to herein as “layering defects.” Layering defects may also include printed layers with abnormal layer thickness (e.g., layers with a thickness that exceeds a layer thickness threshold) and delamination between printed layers.

Typically, a technician manually performs a quality control process to inspect manufactured aligners. However, this manual quality control process may be very time consuming and prone to error due to the inherent subjectivity of the technician. As such, embodiments of the present invention may provide a more scalable, automated, and/or objective aligner quality control process.

In the use case of transparent dental appliances (e.g., aligners, retainers), detecting quality issues may enable fixing the transparent dental appliance to remove the quality issue, preventing the shipment of a malformed or subpar transparent dental appliance, and/or remanufacture of the malformed transparent dental appliance prior to shipment. In some embodiments, the identification of quality issues may be based on comparing an image of a transparent dental appliance with a digitally generated model of the transparent dental appliance. In some embodiments, the digital model for each transparent dental appliance may be included in a digital file associated with the aligner. Optionally, the digital file associated with the manufactured transparent dental appliance may provide a digitally approximated property (e.g., an outer surface of the transparent dental appliance, a two-dimensional projection of the outer surface onto a plane, etc.) of the manufactured transparent dental appliance.

The digitally generated model of the transparent dental appliance and/or the digitally approximated property of the transparent dental appliance may be based on a manipulation of a digital model of a dental arch associated with a treatment stage of a treatment plan in some embodiments. In some embodiments, the identification of the quality issues may be based on comparison of an approximated first property of the transparent dental appliance and a determined second property of the transparent dental appliance (as determined from one or more image of the transparent dental appliance). Embodiments may improve detection results by eliminating human errors (e.g., false positives and false negatives). Further, embodiments may reduce the amount of time it takes to perform quality control, thereby decreasing lead-time of aligners that may enable distributing the transparent dental appliances to customers as scheduled.

In some embodiments, machine based defect detection systems and methods may be implemented in the inspection of molds for orthodontic aligners prior to the manufacturing of orthodontic aligners. In other embodiments, machine based defect detection systems and methods may be implemented in the inspection of orthodontic aligners and/or other dental appliances manufactured by direct fabrication. In other embodiments, machine based defect detection systems and methods may be implanted in the inspection of orthodontic aligners formed over 3D printed objects (e.g., over 3D printed molds). Defect detection may also be performed for other dental appliances, such as palatal expanders, tooth attachments, prefabricated attachment templates used to place attachments on teeth, sleep apnea devices, mouth guards, retainers, and so on.

Various software and/or hardware components may be used to implement the disclosed embodiments. For example, software components may include computer instructions stored in a tangible, non-transitory computer-readable media that are executed by one or more processing devices to perform image based quality control on customized manufactured transparent dental appliances (e.g., aligners). The software may setup and calibrate cameras included in the hardware components, capture images of transparent dental appliances from various angles and/or directions using the cameras, generate a digital model for the transparent dental appliances, perform analysis that compares the digital model of a transparent dental appliance with the image of the transparent dental appliance to detect one or more quality issues (e.g., deformation, cutline variation, etc.), and classify transparent dental appliances based on results of the analysis and/or based on application of machine learning.

In some implementations, a digital file associated with transparent 3D dental appliance (e.g., orthodontic aligner) that is customized for a dental arch of patient and undergoing inspection may be received. In some embodiments, the dental appliance includes identifying information, such as a custom barcode or part identification number. A first image of the transparent 3D dental appliance may be generated using one or more imaging devices (e.g., a camera, a blue laser scanner, a confocal microscope, a stereo image sensor, an X-ray device, etc.). The dental appliance identification information may be captured in the first image and interpreted by the IBQC system. Optionally, a technician may also manually input this information at an IBQC system so that the IBQC system can retrieve the digital file. In still further embodiments, a dental appliance sorting system may sort a series of dental appliances in a known order. The IBQC system may retrieve the dental appliance order from the dental appliance sorting system in order to know which of the dental appliances are currently being inspected and the order in which they arrive at the station. Optionally, the dental appliance may arrive at the IBQC system in a tray carrying the dental appliance identifying information (e.g., RFID tag, barcode, serial numbers, etc.), which is read by the inspection system. Thereafter, the IBQC system may retrieve the digital file associated with the dental appliance based on the dental appliance identification information.

In embodiments, an IBQC system includes an improved design including a plurality of fixed side view cameras that may operate together to substantially speed up image-based defect detection as compared to prior IBQC systems. In embodiments, the IBQC system may include a top view camera and multiple side view cameras. The IBQC system may additionally include a transparent platform configured to support a transparent 3D object (e.g., dental appliance) during imaging. The IBQC system may further include a first lighting system for outputting a first illumination during imaging by the top view camera and a second lighting system for outputting second illumination during imaging by the multiple side view cameras. The top view camera may generate one or more top view images of a transparent 3D object at a first time during output of the first illumination. The top view image(s) may be used to determine an identifier (ID) of the transparent 3D object and/or to perform defect detection of the transparent 3D object. Additionally, the multiple side view cameras may simultaneously or nearly simultaneously generate respective side view images of the transparent 3D object at a second time during output of the second illumination.

The side view images may also be used to perform defect detection, each for a different region or view of the transparent 3D object. The first and second lighting systems may be disposed beneath the transparent platform, and may be configured to illuminate the transparent 3D object through the transparent platform during image capture. The side view cameras may each be positioned above a plane of the transparent platform and may have an angle (e.g. each may have a same angle) relative to the transparent platform. The side view cameras may be disposed about the transparent platform above a plane of the transparent platform and angled relative to the transparent platform, and may be configured to generate a plurality of images of the transparent 3D object from a plurality of directions. For example, the side view cameras may generate a set of side view images, where the images of the set may each be captured by a different camera simultaneously. By using multiple side view cameras in parallel to capture images of a plurality of different regions or views of the transparent 3D object at a same time, inspection of the transparent 3D object can be quickened considerably as compared to systems that use only a single side view camera.

Embodiments discussed herein provide an improved IBQC system that is cheaper and more accurate than prior IBQC systems. The IBQC system in embodiments produces brighter images than prior IBQC systems, where the images show greater contrast and more vivid surfaces than prior IBQC systems. In embodiments, the side view cameras and lighting systems have respective angles to one another and to the transparent platform that are selected to provide an optimal depth of focus, uniform illumination, and field of view.

Some embodiments are discussed herein with reference to orthodontic aligners (also referred to simply as aligners), which are a type of transparent 3D object. However, embodiments also extend to other types of dental appliances, such as orthodontic retainers, orthodontic splints, sleep appliances for mouth insertion (e.g., for minimizing snoring, sleep apnea, etc.), palatal expanders, tooth attachments, and so on. Embodiments also apply to other types of transparent 3D objects. Other transparent 3D objects may include 3D printed palatal expanders, removable mandibular repositioning devices, and removable surgical fixation devices. Accordingly, it should be understood that embodiments herein that refer to aligners also apply to other types of dental appliances and/or transparent 3D objects, and in particular to other types of transparent dental appliances.

The dental appliances described herein may be formed based on performing 3D printing of a mold, and then thermoforming the dental appliance over the mold. The dental appliances may alternatively be directly printed via 3D printing. In both instances, the same or similar quality control operations may be performed to detect defects in the dental appliances.

In the embodiments disclosed herein, each aligner or other dental appliance (e.g., removable surgical fixation devices, removable mandibular repositioning appliances, removable palatal expanders) that is manufactured may be sent to an image based quality control (IBQC) station that detects one or more quality issues (e.g., deformation) with the aligners. Alternatively, aligners that are flagged for quality inspection may be sent to the IBQC station. For example, the digital files of aligners may be input into a machine learning model, numerical simulation, rules engine and/or other module to determine whether there is an increased chance that any of those aligners will have defects. The machine learning model, numerical simulation, rules engine and/or other module may identify a subset of the aligners that are to be inspected using the IBQC system. Optionally, the IBQC systems and methods may classify the inspected aligners as deformed, possibly deformed, or not deformed, and may also provide a recommendation (e.g., requiring further inspection, requires remanufacturing, approved, etc.) including the results of its analysis.

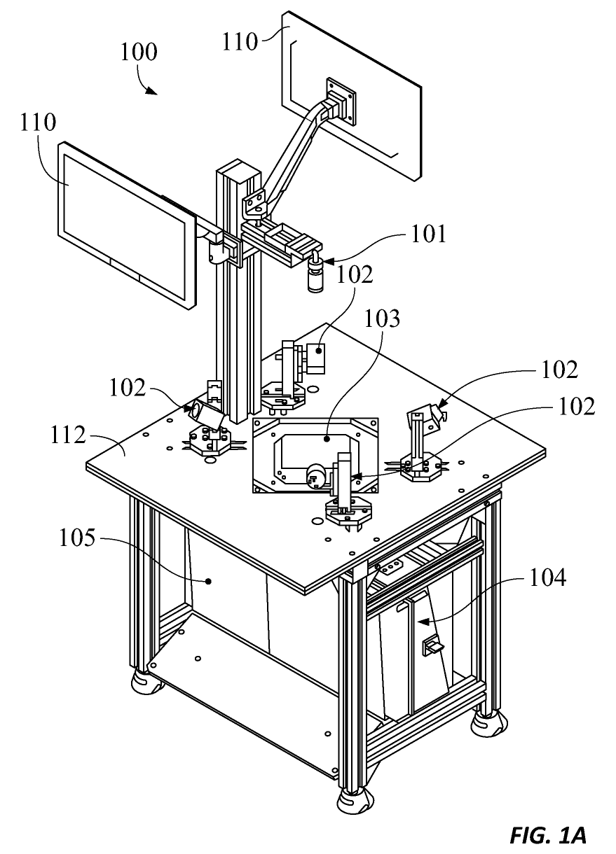

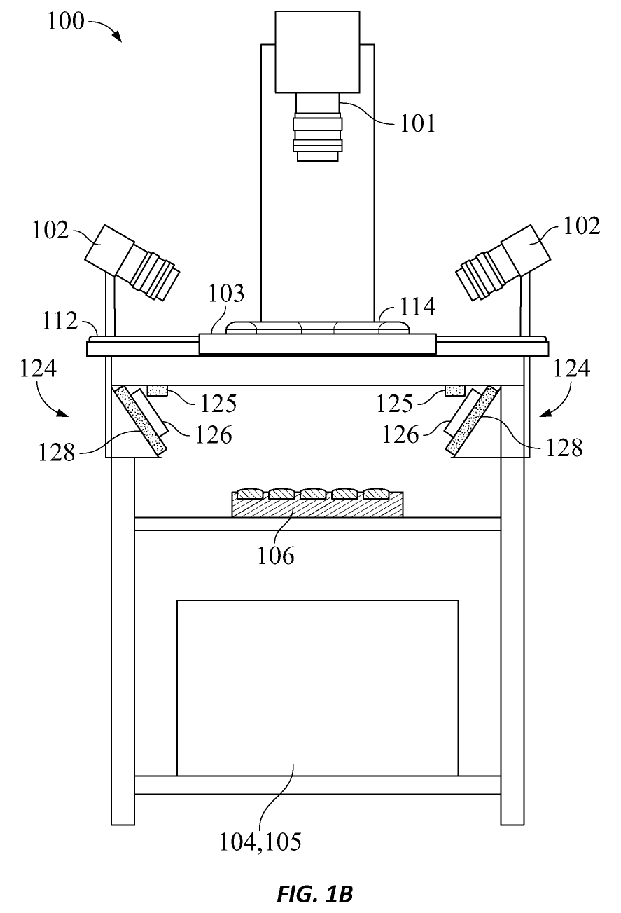

Referring now to the figures, FIG. 1A illustrates a perspective view of one embodiment of an IBQC system 100 that performs automated defect detection of transparent three-dimensional (3D) objects, in accordance with embodiments of the present disclosure. FIG. 1B illustrates a side view of the IBQC system of FIG. 1A, in accordance with embodiments of the present disclosure.

With reference to FIGS. 1A - B, the IBQC system 100 may include a table 112 with a transparent platform 103 disposed within a cavity in the table 112. In embodiments, the transparent platform 103 is a fixed platform (e.g., without actuators to move the platform, rotate the platform, etc.). Additionally, a vertical support that supports a top view camera 101 and one or more displays 110 may be mounted to the table 112.

In some embodiments, transparent platform 103 (e.g., a glass or plexiglass plate) is centered on the table 112. Alternatively, transparent platform 103 may not be centered. As shown, the transparent platform 103 may have a square shape, and a side view camera may be disposed on each side of the square shape of the transparent platform 103. Alternatively, the transparent platform 103 may have other shapes, such as a circle, oval, rectangle, and so on. In one embodiment, a transparent 3D object 114 is disposed on the transparent platform 103 during quality control operations with respect to the transparent 3D object 114.

In embodiments, the transparent platform 103 may include a feature pattern marked on or in the transparent platform 103. The feature pattern may be a geometric pattern that is usable to determine a position and/or orientation of the transparent 3D object 114 relative to the top view camera 101 and/or side view cameras 102 and/or other components of the IBQC system 100 (e.g., relative to a coordinate system of the IBQC system 100). The feature pattern may be a circular pattern of dots and/or other shapes that is arranged about a center of the transparent platform and configured to encircle the transparent 3D object. In embodiments, the transparent 3D object should be placed within an area defined by the feature pattern so that the feature pattern surrounds the 3D object 114. In some embodiments, the number of dots and/or other shapes and a circle diameter of the feature pattern may be selected such that at least four dots and/or other shapes are always in the top camera field of view and the 3D object 114 rarely covers a dot or other shape in the side view images. The 3D object 114 may sit on the platform 104 surrounded by the feature pattern while images of the transparent 3D object are captured and subsequently processed by a processing logic in embodiments.

As shown, the top view camera 101 may be disposed above the transparent platform 103 and have an imaging axis that is approximately normal to the transparent platform 103 (e.g., to a plane defined by the transparent platform). In embodiments, the top view camera 101 is approximately centered above the transparent platform 103, and an optical axis of the top view camera 101 is centered on a center of the feature pattern on the transparent platform 103. In some embodiments, the top view camera 101 is a high definition camera. The top view camera 101 may be a two-dimensional camera or a 3D camera (e.g., a pair of cameras that generate a stereo image pair, a camera and associated structured light projector that shines a structured light pattern onto the 3D object 114, and so on). The top view camera 101 may be configured to acquire top view images of the 3D object 114 using certain illumination settings to enable the 3D object 114 to be visible in a top view image. In one embodiment, the top view camera 101 has a fixed position. In some embodiments, the top view camera 101 is configured to capture a wide field of view of the transparent 3D object in a first configuration. In some embodiments, the top view camera 101 is configured to capture a narrow field of view of the transparent 3D object in a second configuration. In some embodiments, the top view camera 101 includes a spectral filter configured to permit light of a wavelength (or wavelength range) output by a first lighting system 106 and to block light outside of the wavelength (or wavelength range). This enables external visible light to be filtered out so that it doesn’t reach the top view camera 101. For example, the top view camera 101 may include a spectral filter that transmits light in the infrared or near infrared wavelength(s) (e.g., wavelengths of 820 to 930 nm), and that blocks other wavelengths. In embodiments, the top view camera 101 has flexible positioning, and includes a high range of adjustment capabilities in both spatial and angular coordinates (e.g., can be adjusted in up to five or six degrees of freedom) to ensure proper camera setup. For example, top view camera 101 may be mounted to brackets that allow movement in three orthogonal directions and tilting around two axes in embodiments. Once adjusted, the top view camera 101 may remain at a fixed position until further adjusted.

Multiple side view cameras 102 may also have fixed positions about the transparent platform 103. As shown, each of the side view cameras 102 may be positioned above a plane of the transparent platform 103, and may have a fixed angle relative to the transparent platform (e.g., to the plane of the transparent platform). In embodiments, the side view cameras 102 are positioned around the center of the feature pattern on the transparent platform 103, with their optical axes tilted at an angle and aimed at the center of the feature pattern on the transparent platform 103. In embodiments, each of the side view cameras 102 has a same angle relative to the plane defined by the transparent platform 103. The side view cameras 102 may be two-dimensional cameras or 3D cameras. In one embodiment, the side view cameras are high resolution cameras and/or high speed cameras (e.g., capable of capturing an image up to every millisecond. The side view cameras 102 may have fixed positions, and may each acquire one or more images of different regions or views of the 3D object 114. In some embodiments, the side view cameras 102 each include a spectral filter configured to transmit light of a wavelength output by a second lighting system 124. This enables external visible light to be filtered out so that it doesn’t reach the side view cameras 102. For example, the side view cameras 102 may include a spectral filter that transmits light in the infrared or near infrared wavelength(s) (e.g., 820 to 930 nm), and that blocks other wavelengths.

In embodiments, the side view cameras 102 have flexible positioning, and include a high range of adjustment capabilities in both spatial and angular coordinates (e.g., can be adjusted in up to five or six degrees of freedom) to ensure proper camera setup. For example, side view cameras 102 may be mounted to brackets that allow movement in three orthogonal directions and tilting around two axes in embodiments. Once adjusted, the side view cameras 102 may remain at a fixed position until further adjusted. In some embodiments, side view cameras 102 each include a lens having a focal plane, an image sensor having an image plane, and a tilt shift adapter that causes the focal plane to have an angle relative to the image plane. The tilt shift adapter may ensure an increased depth of field of the side view images in embodiments.

In embodiments, depending on the size of the inspected transparent 3D object 114, system design constraints, the footprint of the system, space required for interaction with other equipment (e.g., a robotic arm), and the conditions for obtaining high-quality images of transparent objects described in the application, a specific focal length of the lenses and the size of the camera sensor can be selected as well as lights sizes. For example, for a square inspection zone size of 100 mm, to have an upper projection of the system not exceeding 1 m with a camera sensor size of 10x10 mm, it is necessary to use lenses with a focal length of 25-35 mm for side cameras and 25-75 mm for the top camera, a top light 106 with the size of 200x200 mm, a matte white plate 126 for the second light system should have the size of 200x120 mm.

The IBQC system 100 includes multiple light sources, which may include one or more first light sources that are part of a first lighting system 106 and one or more second light sources that are part of a second lighting system 124. In some embodiments, the first light sources have an axis that is approximately normal to the transparent platform. The first and second lighting systems 106, 124 may both be disposed beneath the transparent platform 104 in embodiments. Each lighting system may include one or more light sources (also referred to as lighting emitting elements). Each light source may include at least one of an incandescent light bulb, a fluorescent light bulb, a light-emitting diode (LED), a neon lamp, and so forth. In one embodiment, each of the light sources may emit light of a particular wavelength or spectrum. For example, in one embodiment each of the light sources may emit infrared or near infrared light (e.g., light having a wavelength range of 820-930 nm). In embodiments, the first and/or second lighting systems 106, 124 are configured to provide a spatial distribution of luminance that makes defects in the transparent 3D object 114 visible in images. The first and second lighting systems 106, 124 may be configured to achieve a proper contrast of build lines in images, and ensure the absence of glare from external light.

The first lighting system 106 may be a top view lighting system that is used to provide a first illumination that uniformly illuminates the transparent 3D object 114 during image capture by top view camera 101. In some embodiments, top view camera 101 is a variable lens aperture imaging system with at least two lens aperture settings (e.g., lens F number settings). In one embodiment, the variable lens aperture imaging system has a first lens aperture number setting of about 6.0 (e.g., about 5.6-8) and a second lens aperture number setting of about 2.0 (e.g., around 1.8-2.5). The first lens aperture may be used to obtain images for reading a laser marking in the 3D object 114. The second lens aperture may be used for imaging used for defect detection. Changing lens aperture can be done automatically by using a motorized lens in embodiments. This allows the lens to be controlled remotely.

The second lighting system 124 may be a side view lighting system that is a lighting assembly including a plurality of lighting sections that provide second illumination that uniformly illuminates the transparent 3D object 114 during image capture by the side view cameras 102. Each lighting section of the second lighting system 124 may include one or more light sources 125, a matte white plate 126 configured to direct light output by the one or more light sources 125 through the transparent 3D object and towards a respective side view camera 102 that is pointed at the lighting assembly 124, and a matte black plate 128 disposed around the matte white plate 126 and configured to absorb light output by the one or more light sources 125. The lighting system 124 may be configured, positioned, and oriented to provide uniform illumination for the side view cameras 102.

In one embodiment, each lighting section is configured to provide uniform illumination of transparent 3D object 114 for the side view camera 102 pointed at the lighting section. In some embodiments, all of the lighting segments illuminate the transparent 3D object at the same time, and the side view cameras 102 each capture images simultaneously (or nearly simultaneously), resulting in a low cycle time for inspection. Alternatively, the lighting segments may illuminate the transparent 3D object 114 in sequence. For example, a first lighting segment may provide illumination of the transparent 3D object during image capture by a first side view camera 102 that is opposite the first lighting segment and pointed at the first lighting segment. Subsequently, a second lighting segment may provide illumination of the transparent 3D object during image capture by a second side view camera 102 that is opposite the second lighting segment and pointed at the second lighting segment. Subsequently, a third lighting segment may provide illumination of the transparent 3D object during image capture by a third side view camera 102 that is opposite the third lighting segment and pointed at the third lighting segment. Subsequently, a fourth lighting segment may provide illumination of the transparent 3D object during image capture by a fourth side view camera 102 that is opposite the fourth lighting segment and pointed at the fourth lighting segment. If additional lighting segments and associated side view cameras are included, then each of these lighting segments and associated side view cameras may operate in succession in the above described manner.

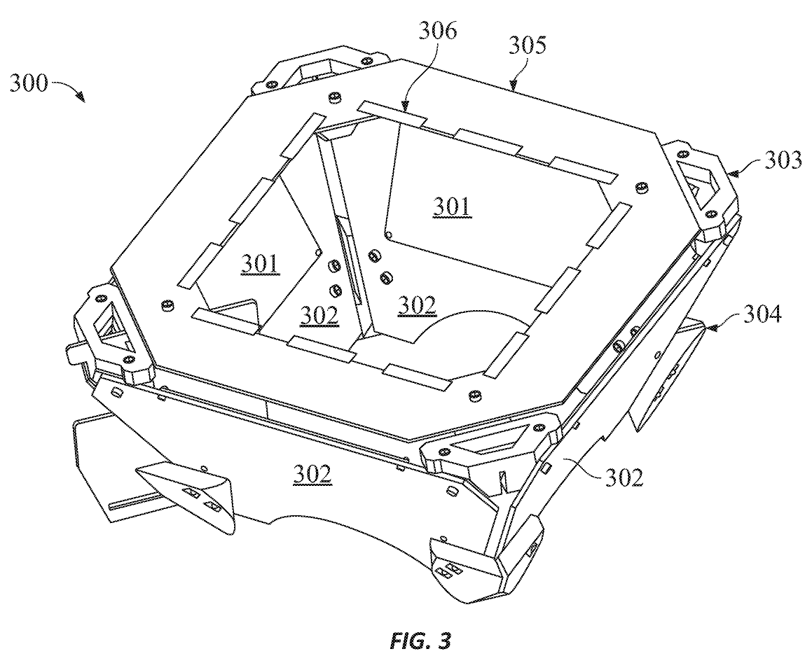

In one embodiment, the IBQC system 100 includes four side view cameras and four lighting segments. In other embodiments, the IBQC system 100 includes fewer or more than four side view cameras and associated lighting segments (e.g., three, five, six, seven, eight, etc.). The IBQC system 100 may cycle through use of the multiple side view cameras 102 and associated lighting segments in rapid succession in some embodiments. A more detailed view of the second lighting system 124 and its Individual lighting segments are shown in FIG. 3. Whether the side view cameras 102 capture images simultaneously or in rapid succession, the inspection timespan may be reduced from about 10 seconds (e.g., for systems with a single side view camera that takes images from multiple positions about the transparent 3D object 114) down to about 4 seconds.

IBQC system 100 may include one or more controllers 104 and/or computing devices 105. The controller(s) 104 and/or computing device(s) 105 may be configured to control and manage the various components of the IBQC system (e.g., top view camera 101, side view cameras 102, first lighting system 106, second lighting system 124, etc.). The controller(s) 104 and/or computing device(s) 105 may handle image capture from the cameras 101, 102, may preprocess images before use (e.g., before processing the images to identify an ID of the transparent 3D object and/or detect defects in the transparent 3D object 114), and may process the images to identify an ID of the transparent 3D object and/or detect defects in the transparent 3D object 114. The controller(s) 104 and/or computing device(s) 105 may additionally integrate with external systems (e.g., to retrieve digital files and/or information about the transparent 3D object 114), store defect detection results about the transparent 3D object, etc.

In embodiments, controller(s) 104 and/or computing device(s) 105 may interact with a conveyor that may deliver transparent 3D objects to the IBQC system 100 and/or that may transfer 3D objects away from the IBQC system 100. In embodiments, controller(s) 104 and/or computing device(s) 105 may interact with one or more robotic arms to cause the robotic arms to pick transparent 3D object 114 from a conveyor, place the transparent 3D object 114 on transparent platform 103, retrieve the transparent 3D object 114 from the transparent platform 103, and/or place the transparent 3D object 114 on a conveyor. The robot arm may be part of the IBQC (defect detection) system or a related system. For example, the computing device 105 may determine a position and/or orientation of the transparent 3D object 114 on transparent platform 103, and may provide coordinates to the robotic arm for picking up the transparent 3D object 114 based on the determined position and/or orientation of the transparent 3D object 114.

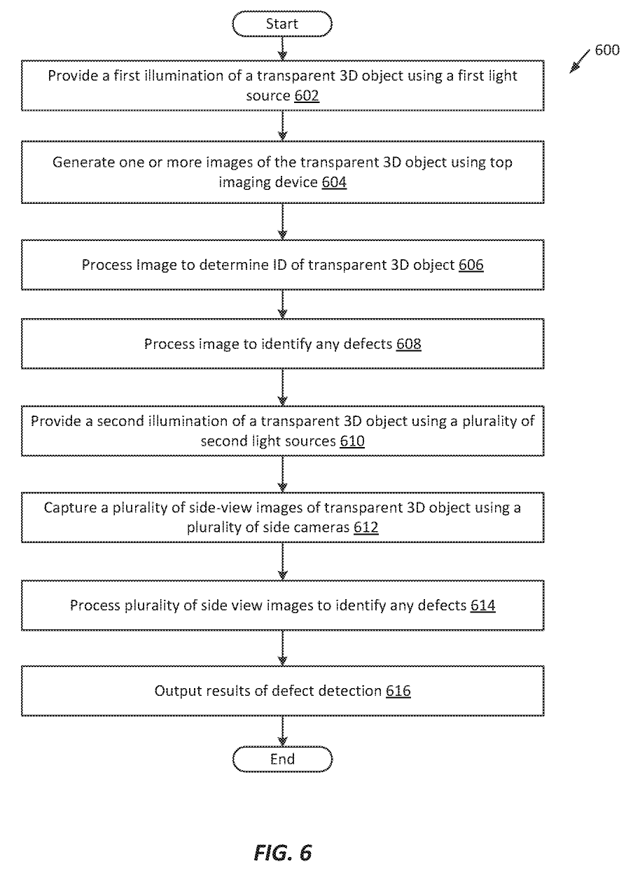

The controller(s) 104 may control the timing of when to activate each of the cameras 101, 102, and/or lighting systems 106, 124, control intensities at which light is generated, and so on. In embodiments, controller(s) 104 provide automated lighting control. For example, controller(s) 104 may send instructions to the top view camera 101 and first lighting system 106 to cause the top view camera 101 to capture one or more top view images of the transparent 3D object disposed on the transparent platform 103 and illuminated by first lighting system 106. The controller(s) 104 may additionally send instructions to the side view cameras 102 and second lighting system 124 to cause the side view cameras 102 to capture side view images of multiple different regions or views of the transparent 3D object 114 disposed on the transparent platform 103 and illuminated by the second lighting system 124. The side view cameras 102 may be instructed to generate images at a same time or in sequence in embodiments. Controller 104 may cause the top view camera 101 and/or side view cameras 102 to capture images of the 3D object 114. In embodiments, controller 104 may then receive the images and provide the images to computing device 105 for processing according to the methods shown in FIGS. 6-10. The captured images may be sent to the computing device 105, and an image inspection module on the computing device 105 may analyze the images of the transparent 3D object 114 to determine whether any defects are present in the transparent 3D object 114.

In embodiments, a first image of the 3D object 114 may be generated by the top view camera 101, and may include a representation of an identifier (ID), such as a part number, printed on or formed in (e.g., as a laser marking) the 3D object 114. The first image may include a symbol sequence displayed on a distinct region or view on the 3D object 114. In one embodiment, the first image of the 3D object 114 may be generated by the top view camera 101 while the first light source 106 is activated to provide a wide light field. A laser marking may provide an identification of a particular transparent 3D object (e.g., of a particular dental appliance), and may correspond to a particular digital model of the 3D object. The computing device 105 may perform optical character recognition (OCR) on the symbol sequence to determine the ID. In other embodiments, a technician may manually enter the ID associated with the 3D object at an inspection station using an interface, such as a user interface (UI) output in display 110. In other embodiments, the ID may be obtained based on a known order and/or position of the 3D object in an object sorting system. For example, a robotic object sorting system may retrieve 3D objects and place them at a particular position in a staging area. A robotic arm may then retrieve the 3D object from the staging area, and may determine the ID associated with the 3D object based on the position of the 3D object in the staging area. The determined ID may then be sent to the computing device 105.

The computing device 105 may associate images of the 3D object 114 with the determined ID. In one embodiment, processing logic may determine a digital file associated with the ID. The digital file may include one or more properties associated with the 3D object 114. In one embodiment, a first property may include a geometry associated with at least one surface of the 3D object 114. In another embodiment, a second property may include the composition of the 3D object 114.

In one embodiment, an image is generated by the top view camera 101 while the first lighting system 106 is set to provide a narrow light field. The image may then be used to determine contours of the 3D object. In one embodiment, a plurality of side view images may be generated by the side view cameras 102. Each of the plurality of side view images may depict a distinct view or region of the 3D object 114. In one embodiment, while the side view images are generated, one or more segments of the second lighting system 124 are activated. In some embodiments, a camera lens diaphragm is contracted (at least partially closed) during generation of one or more of the side view images to achieve a large focus depth. This can facilitate obtaining a sharp picture in a side projection at large angle with vertical.

Quality inspection of transparent 3D objects (e.g., orthodontic aligners, retainers, etc.) may be conducted by analyzing images (e.g., 2D images) taken from both top view camera 101 and side view cameras 102.

In embodiments, computing device 105 preprocesses the images to place the images in better format for defect detection. Preprocessing the images may include, for example, resizing, cropping, rotation, flipping, affine transformations, noise reduction and/or filtering (e.g., Gaussian filtering to smooth an image and reduce noise, median filtering to remove noise, bilateral filtering to smooth an image while preserving edges), color and/or intensity adjustments (e.g., grayscale conversion, histogram equalization to improve contrast, gamma correction, normalization, etc.), edge detection and/or feature extraction (e.g., canned edge detection, application of a Sobel Operator, application of a Laplacian Operator, etc.), image thresholding and/or segmentation (e.g., global thresholding, adaptive thresholding, application of a watershed algorithm, etc.), and/or morphological operations (e.g., dilation, erosion, etc.). In embodiments, computing device 105 may adjust image resolution and/or scale to achieve optimal inspection quality and speed. In embodiments, computing device 105 may perform segmentation using traditional image processing algorithms and/or using an artificial intelligence (AI) model (e.g., a machine learning model) trained to perform semantic segmentation or instance segmentation to identify the transparent 3D object in an image. The image may then be cropped to remove portions of the image that do not show the transparent 3D object in embodiments. Computing device 105 may process images using one or more image processing algorithms and/or trained artificial intelligence (AI) models to identify defects. In some embodiments, computing device 105 processes the images using one or more AI models trained on various defect images. In some embodiments, computing device 105 processes the images using one or more defect detection services (e.g., which may identified defects related to trimming and/or deformation).

In some embodiments, a feature pattern on the transparent platform 103 may be used to determine a rotation angle and/or a position in space of the 3D object for each image. Knowing the position of four dots/shapes or more, computing device 105 and/or controller 104 can determine a position and orientation of the transparent 3D object in an image based on calibration information of the camera relative to the feature pattern. Also there may be some dots/shapes marked with additional dots/shapes of the same or smaller size and/or shape outside the circle and/or on the circle. This will allow to determine the rotation angle exactly. A round dot is an object that can be detected on an image quickly and reliably.

In some embodiments, the feature pattern on the transparent platform 103 is used to determine a blurriness measure for one or more regions of a captured image, and are used to calibrate the IBQC system 100.

Once computing device 105 receives an image of the 3D object 114, the image may be processed to determine whether the 3D object 114 depicted in the image includes any defects. In one embodiment, the computing device 105 may comprise one or more trained artificial intelligence (AI) model (e.g., an artificial neural network, deep neural network, machine learning model, etc.) that has been trained to identify defects in images of 3D objects. The AI model may output a confidence value along with an indication of whether or not a defect has been identified (and/or a type of defect that has been identified). In some embodiments, computing device 105 includes additional logic or modules for performing defect detection, such as based on comparison between a digital 3D model of the transparent 3D object and images of the transparent 3D object. The AI model and/or additional logic/modules may identify discrepancies between a planned cut line and an actual cut line of a transparent 3D object such as an orthodontic aligner, and/or may identify deformation in a transparent 3D object in embodiments.

In embodiments, defect detection results may be output to display 110. Additional information about the transparent 3D object may also be presented on the display. In embodiments, the IBQC system 100 interacts with a manufacturing enterprise system by sending information about defects, retrieving 3D models of the inspected transparent 3D object (e.g., dental appliance), and so on. The IBQC system 100 may also manage interactions with one or more conveyors and/or one or more robotic arms.

In some embodiments, a calibration procedure may be performed before the IBQC system’s 100 first run and during maintenance. The calibration procedure may be performed to position the cameras precisely so that image scale and angular orientation allow for accurate linear distance measurements, which may be used for deformation estimation. In emodiments, the calibration process is fully software-controlled and uses parameters of the feature pattern as captured in images, known parameters of the feature pattern, and/or the geometric parameters of the top and side imaging systems (such as camera tilt angles, the distance from the lens's rear principal point to the image plane, the distance from the feature pattern center to the lens's front principal point, etc.) stored in a configuration file to estimate mechanical adjustments for proper camera operation. Based on the calibration procedure, mechanical adjustments may be made by a user in accordance with the determined mechanical adjustments to properly calibrate the IBQC system 100.

In some embodiments, the top view camera 101 and/or side view cameras 102 are replaceable, and may be removed and replaced with different cameras having different properties (e.g., different angular field of view, depth of focus, resolution, etc. Additionally, distances of cameras from transparent platform 103 and/or angles of cameras relative to transparent platform 103 may be adjusted. If one or more cameras are replaced and/or adjusted, then a calibration procedure may be run to recalibrate the ICQB system 100.

In some embodiments, IBQC system 100 includes advancements over IBQC lighting systems of U.S. Patent No. 11,189,021, issued Nov. 30, 2021, which is incorporated by reference herein in its entirety. In some embodiments, IBQC system 100 includes advancements over IBQC lighting systems of U.S. Patent No. 10,783,629, issued Sep. 22, 2020, which is incorporated by reference herein in its entirety.

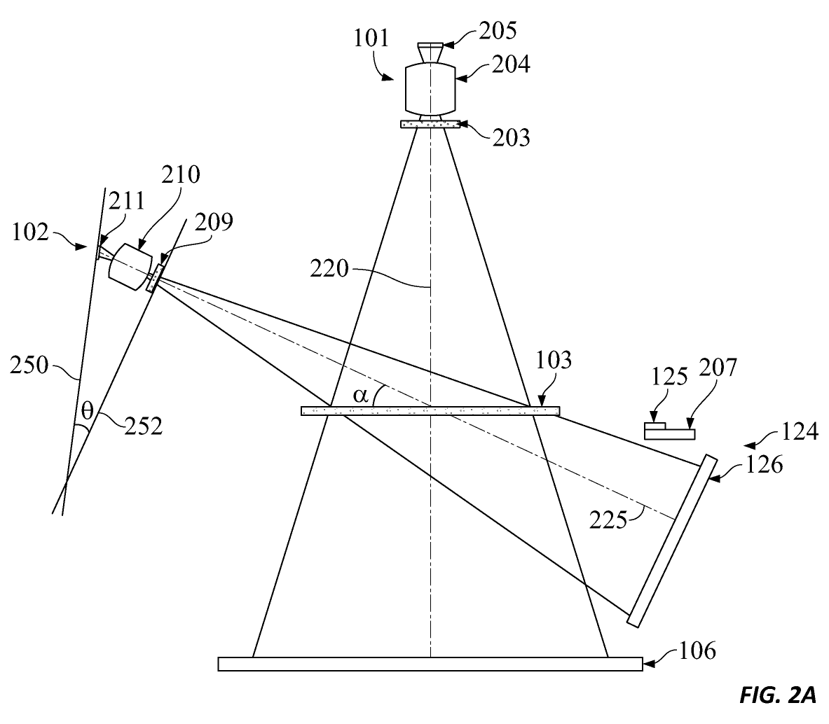

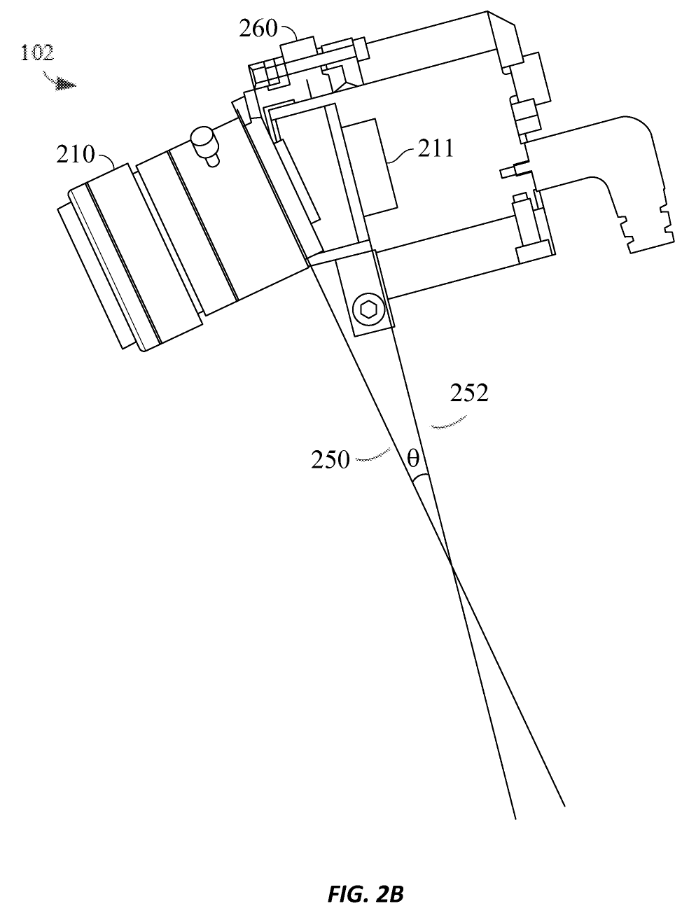

FIG. 2A is an optical diagram of an image based quality control system (e.g., of IBQC system 100), in accordance with embodiments of the present disclosure. FIG. 2A shows the optical components of the IBQC system 100 and their relative positions. Top view camera 101 and a side view camera 102 are illustrated. The top view camera 101 includes an image sensor 205, a lens 204, and a spectral filter 203. As shown, lens 204 is positioned between image sensor 205 and spectral filter 203. However, in an alternative embodiment spectral filter 203 may be positioned between image sensor 205 and lens 204. The side view camera 102 includes an image sensor 211, a lens 210, and a spectral filter 209. As shown, lens 210 is positioned between image sensor 211 and spectral filter 209. However, in an alternative embodiment spectral filter 209 may be positioned between image sensor 211 and lens 210.

Side view camera 102 has a focal plane 252 (also referred to as a lens plane) that is defined by lens 210, where imaging axis 225 is normal to the focal plane 252. Additionally, side view camera 102 has an image plane 250 that is defined by a surface of image sensor 211. A tilt shift adapter (not shown) causes the focal plane 252 to have an angle ϴ relative to the image plane 250. This causes the image plane 250 to be tilted at angle ϴ to increase the depth of field for the tilted image plane. In embodiments, the angle ϴ at which the image plane 205 is tilted with respect to the focal plane 252 is a function of a tilt angle α of the focal plane 252 relative to a plane defined by the transparent platform 103 in embodiments. Since the side view camera 102 (e.g., focal plane 252) is tilted relative to the transparent platform 103 (and therefore relative to the transparent 3D object placed on the transparent platform 103), this can cause images that are captured to be in focus at a center of the images and blurry at a top and bottom of the images. However, by tilting the image plane 250 at an angle ϴ relative to the focal plane 252 an appropriate amount that is a function of the angle α, the images captured by side view camera 102 have an increased focal depth and the top, center and bottom of the images all remain in focus.

In embodiments, the closer that angle α is to 90 degrees, the higher the accuracy of defect detection for some types of defects, but the lower the accuracy of defect detection for other types of defects. Accordingly, in embodiments the angle α is selected to optimize accuracy of each of the types of defects that are detectable by IQCB system 100. In some embodiments, the angle α is about 15-50 degrees (e.g., 15, 20, 25, 30, 35, 40, 45 or 50 degrees). In one embodiment, for an angle α of 25 degrees, the tilt shift adapter provides an angle ϴ of 10.5 degrees, for other embodiments for an angle α of 15 an angle ϴ of 17.7 degrees, for an angle α of 20 an angle ϴ of 13.2 degrees, for an angle α of 30 an angle ϴ of 8.4 degrees, for an angle α of 35 an angle ϴ of 6.8 degrees, for an angle α of 40 an angle ϴ of 5.7 degrees, for an angle α of 45 an angle ϴ of 4.6 degrees, for an angle α of 50 an angle ϴ of 4.0 degrees, so the angle ϴ is about 0-35 degrees depending on angle α. The aperture values of the camera lenses 204, 210 are selected to ensure an appropriate depth of field for quality imaging.

A transparent 3D object to be inspected is positioned approximately centered on the transparent platform 103 so that the transparent 3D object is surrounded by the feature pattern of the transparent platform 103. In embodiments, top view camera 101 has an imaging axis 220 that is centered on transparent platform 103, which includes a feature pattern as discussed above. Similarly, side view camera 102 has an imaging axis 225 that is centered on transparent platform 103. In embodiments, the image scales for the top view camera 101 and side view camera 102 are chosen so that the feature pattern on the transparent platform 103 occupies approximately 90% of the image size (e.g., an area) of images captured by top view camera 101 and side view camera 102.

First lighting system 106 (also referred to as bottom lighting system or top view lighting system) is positioned beneath transparent platform 103, and has a center that aligns with a center of transparent platform 103 in embodiments. In one embodiment, first lighting system 106 is a flat backlight. First lighting system 106 is situated a certain distance below the transparrent platform 103.

Second lighting system 124 (e.g., side imaging system) includes a white matte light-scattering plate 126 illuminated by one or more light sources 125, which may be located above an additional light-scattering plate 207, which ensures uniform luminance distribution on the white matte light-scattering plate 126. The size of the white matte light-scattering plate 126 is designed to cover the background of images captured by side view camera 102. For example, the white matte light-scattering plate 126 may have a size that is approximately equal to a field of view and/or angular field of view of side view camera 102 at the distance between side view camera 102 and the white matte light-scattering plate 126. In embodiments, the side view camera 102 is positioned at an angle and distance relative to transparent plate 103 that images captured by side view camera 102 approximately capture the full feature pattern of the transparent plate 103. The white matte light-scattering plate 126 may be sized and positioned at an angle and distance relative to the transparent plate 103 that the field of view of the side view camera 102 is approximately equal to the size of the white matte light-scattering plate 126. In some embodiments, white matte light-scattering plate 126 includes multiple (e.g., four) sections. Alternatively, there may be separate light-scattering plates for each section. Each section may be positioned on an opposing side of the transparent platform from a side view camera facing the section of the light-scattering plate 126. For example, a side view camera may be on a left side of the transparent platform and above a plane of the transparent platform, and an associated light scattering plate 126 may be on a right side of the transparent platform and below the plane of the transparent platform. In one embodiment, each section or plate has a planar surface, where an imaging axis of a side view camera facing the section or light scattering plate is normal to the planar surface of the section or light scattering plate. In some embodiments, light reflectance properties of matte light-scattering plate 126 are the following: reflectance 0.85–0.95, gloss (60°) <5 GU (very matte), bidirectional reflectance distribution function uniformity ±10% vs. ideal Lambertian; for additional light-scattering plate 207 light transmission properties are following in some embodiments: surface finish - polished / glossy, total transmittance 70–95%, haze ≥90%, gloss (60°) >70 GU.

The locations, sizes, and shapes of the first lighting system 106 and second lighting system 124 are fixed to provide appropriate luminance distribution on the transparent platform 103 where the inspected transparent 3D object is to be placed. This distribution ensures that defects in the transparent 3D object are visible in the images with sufficient contrast for reliable detection.

The first lighting system 106 forms the background in the images captured by top view camera 101, and illuminates the transparent 3D object placed on transparent platform 103. Similarly, each lighting assemby of the second lighting system 124 forms the background in images captured by a respective one of the side view cameras 102, and illuminates the transparent 3D object placed on transparent platform 103. Images of the transparent 3D object are created by light emitted from the back lights (first lighting system 106) or side lights (second lighting system 124), refracted by the transparent 3D object, and captured by the appropriate camera lenses 204, 210. The IBQC system 100 may be configured such that light refracted by the transparent 3D object causes a surface of the transparent 3D object to be visible in captured images. The distance from the lighting system 106, 124 and the shape of the light-emitting surface of the lighting system 106, 124 significantly impact the contrast of the transparent 3D object in the images. These factors are chosen so that the background (e.g., first lighting system 106 or matte white light scattering plate 126 occupies the entire image area (e.g., field of view) for a respective top view camera 101 or side view camera 102, and the angular size of the light ensures proper illumination of the transparent 3D object to achieve the necessary contrast for defect detection. In embodiments, the first lighting system 106 include a flat backlight with a uniform luminance distribution across its surface. Each light scattering plate may be positioned proximate to a light source and configured to scatter light from the light source.

FIG. 2B is a diagram of a side view camera 102, in accordance with embodiments of the present disclosure. As shown, the side view camera includes a lens 210 having a focal plane 250 and an image sensor 211 having an image plane 252. The image plane 252 and focal plane 250 are at an angle ϴ relative to one another due to tilt shift adapter 260.

FIG. 3 illustrates a side lighting system 300, which may correspond to second lighting system 124 of FIG. 1A, in accordance with embodiments of the present disclosure. In embodiments, second lighting system 124 is divided into quadrants, and includes a separate lighting segment in each quadrant, which is provided opposite each side view camera 102 to provide a background and backlight for images captured by the associated side view camera 102. In embodiments, side lighting system 300 comprises multiple white matte plates 301 fixed on black matte plates 302. The side lighting system 300 may include a separate white matte plate 301 and black matte plate 302 for each segment in embodiments. The matte white plates 301 and/or matte black plates 302 are secured with brackets 303, 304. Light is emitted from light sources (e.g., LEDs) 306 located above a light-scattering plate 305, which is also fixed in the brackets 303. The positions of the light sources 306, and the distances between the light sources 306, the light-scattering plate 305, and the white plates 301, are chosen to ensure uniform illumination of the white plates 301 in embodiments. Direct light from the light sources 306 is blocked by a black plate (not shown) located above the side lighting system 300 in embodiments. In some embodiments, one or more light curtains can be attached to the brackets 303, 304 to block light from neighboring light sources 306 from illuminating neighboring white plates 301. In some embodiments, by turning on only the light sources 306 corresponding to a single side section of the side lighting system 300, flexible control over lighting can be achieved.

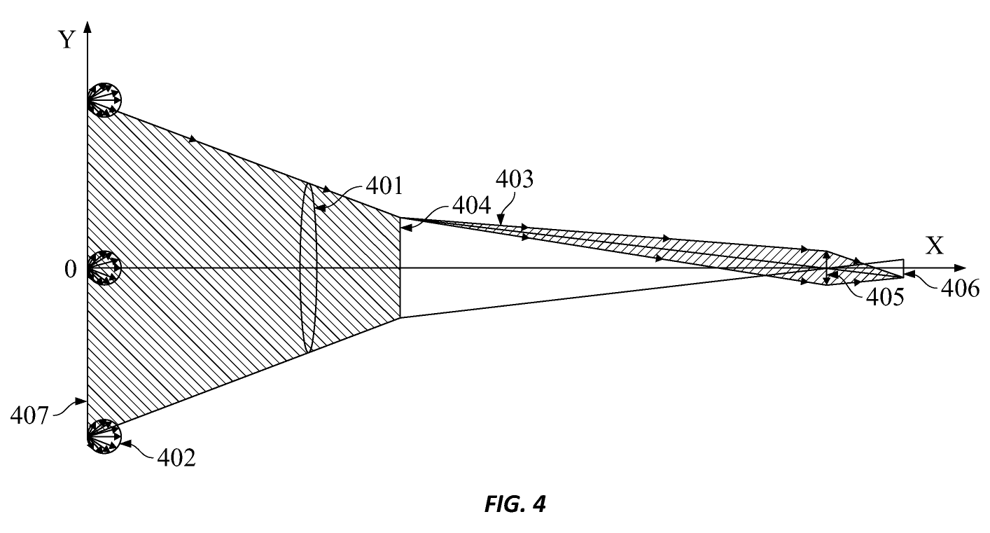

FIG. 4 is a rays propagation diagram for an image based quality control system, in accordance with embodiments of the present disclosure. When an inspected transparent 3D object is positioned on a plane 404 (e.g., which may correspond to transparent platform 103), rays within a solid angle 401 may be deflected by the transparent 3D object. Those rays that fall within the cones formed by a camera lens’s certain marginal rays 403 create an image of the transparent 3D object on a image plane of a camera. Rays that are outside of solid angle 401 and/or that fall outside of the cones formed by the camera lens’s marginal rays 403, are not captured by a camera, and do not form part of a captured image. In an example, if there is no surface of the transparent 3D object in the path of a ray in the solid angle 401, then that ray will appear as a white point or spot on a captured image. However, if there is a surface of the transparent 3D object in the path of the ray, it deflects the ray. If the light (e.g., ray) is deflected out of the cones formed by the camera lens’s certain marginal rays 403, then no light for that ray reaches the camera sensor 406, and a point or spot on the camera sensor 406 is dark as a result. If only a fraction of the rays fall within the cameras lens’s certain marginal rays 403, then an intensity value (e.g., a gray value) between white and black will be captured for the corresponding pixel(s).

A light source 407 (e.g., corresponding to first lighting system 106 or second lighting system 124) can be considered a Lambertian light source with uniform light distribution 402 in embodiments. The brightness of a specific pixel on a camera sensor 406, which is projected through a lens 405 onto the transparent 3D object, is proportional to the amount of light deflected by the transparent 3D object and falling within the solid angle 401 formed by the lens’s marginal rays 403 corresponding to that pixel. The contrast of defects of the transparent 3D object visible in the images depends on the shape, size, and orientation of the light source 407, as well as its luminance distribution.

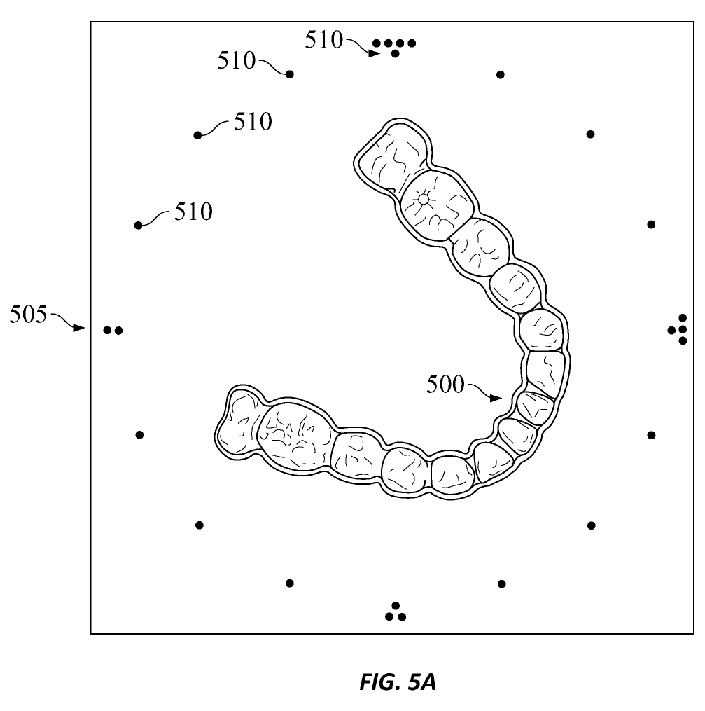

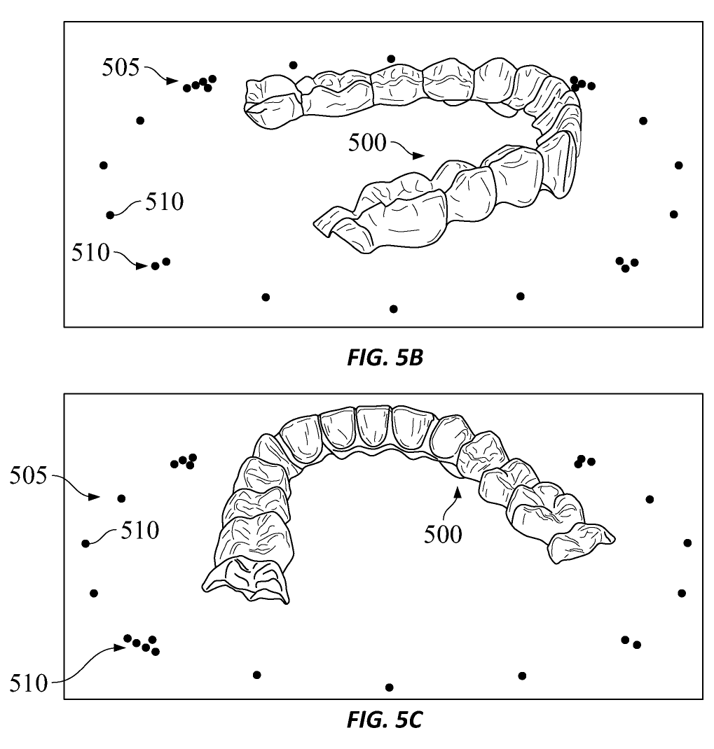

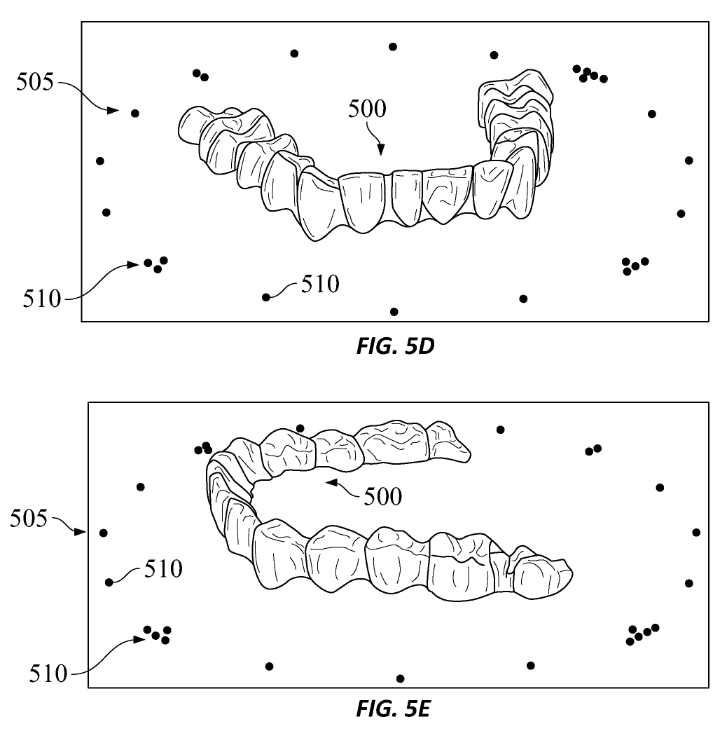

FIG. 5A is an example top view image captured by a top view camera of an image based quality control system, in accordance with embodiments of the present disclosure. The example top view image depicts a transparent 3D object (e.g., a polymeric orthodontic aligner) 500 surrounded by a feature pattern 505. As shown, the feature pattern includes a plurality of features 510, which in the illustrated example are a plurality of dots.

FIGS. 5B-E are an example side view images captured by different side view cameras of an image based quality control system, in accordance with embodiments of the present disclosure. The example side view images each depict the transparent 3D object 500 surrounded by the feature pattern 505 from a different perspective, and show a different portion of the transparent 3D object. As shown, the feature pattern includes a plurality of features 510, which in the illustrated example are a plurality of dots.

FIGS. 6-10 are flow diagrams showing various methods for performing automated defect detection of a transparent 3D object (e.g., a polymeric orthodontic aligner or other transparent dental appliance), in accordance with embodiments of the disclosure. Some operations of the methods may be performed by a processing logic that may comprise hardware (e.g., circuitry, dedicated logic, programmable logic, microcode, etc.), software (e.g., instructions run on a processing device to perform hardware simulation), or a combination thereof. The processing logic may execute on one or many processing devices (e.g., of controller 104 and/or computing device 105 of FIG. 1B). The processing logic may be processing logic of an image inspection module and/or of imager control module in embodiments. Some operations of the methods may be performed by an IBQC system, such as IBQC system 100 of FIGS. 1A - B.

For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

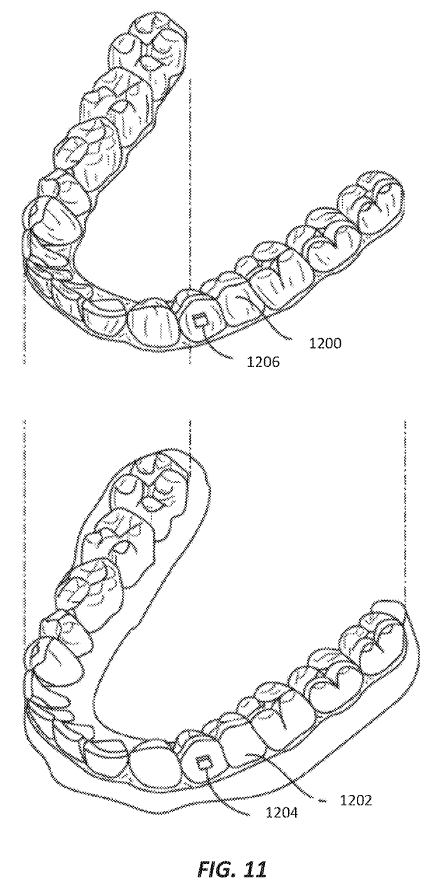

In some embodiments, a mold of a patient’s dental arch may be fabricated from a digital file and a dental appliance such as an orthodontic aligner may be formed over the mold. The fabrication of the mold may be performed by processing logic of a computing device, such as the computing device in FIG. 11. The processing logic may include hardware (e.g., circuitry, dedicated logic, programmable logic, microcode, etc.), software (e.g., instructions executed by a processing device), firmware, or a combination thereof. For example, one or more operations may be performed by a processing device executing a computer aided drafting (CAD) program or module.

To manufacture molds for dental appliances, a shape of a dental arch for a patient at a treatment stage is determined based on a treatment plan. In the example of orthodontics, the treatment plan may be generated based on an intraoral scan of a dental arch to be modeled. The intraoral scan of the patient’s dental arch may be performed to generate a three dimensional (3D) virtual model of the patient’s dental arch (mold). For example, a full scan of the mandibular and/or maxillary arches of a patient may be performed to generate 3D virtual models thereof. The intraoral scan may be performed by creating multiple overlapping intraoral images from different scanning stations and then stitching together the intraoral images to provide a composite 3D virtual model. In other applications, virtual 3D models may also be generated based on scans of an object to be modeled or based on use of computer aided drafting techniques (e.g., to design the virtual 3D mold). Alternatively, an initial negative mold may be generated from an actual object to be modeled (e.g., a dental impression or the like). The negative mold may then be scanned to determine a shape of a positive mold that will be produced.

Once the virtual 3D model of the patient’s dental arch is generated, a dental practitioner may determine a desired treatment outcome, which includes final positions and orientations for the patient’s teeth. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model of the patient’s dental arch at that treatment stage may be generated. The shape of each virtual 3D model will be different. The original virtual 3D model, the final virtual 3D model and each intermediate virtual 3D model is unique and customized to the patient.

Accordingly, multiple different virtual 3D models may be generated for a single patient. A first virtual 3D model may be a unique model of a patient’s dental arch and/or teeth as they presently exist, and a final virtual 3D model may be a model of the patient’s dental arch and/or teeth after correction of one or more teeth and/or a jaw. Multiple intermediate virtual 3D models may be modeled, each of which may be incrementally different from previous virtual 3D models.

Each virtual 3D model of a patient’s dental arch may be used to generate a unique customized physical mold of the dental arch at a particular stage of treatment. The shape of the mold may be at least in part based on the shape of the virtual 3D model for that treatment stage. The virtual 3D model may be represented in a file such as a computer aided drafting (CAD) file or a 3D printable file such as a stereolithography (STL) file. The virtual 3D model for the mold may be sent to a third party (e.g., clinician office, laboratory, manufacturing facility or other entity). The virtual 3D model (e.g., which may be in the form of a digital file) may include instructions that will control a fabrication system or device in order to produce the mold with specified geometries.

A clinician office, laboratory, manufacturing facility or other entity may receive the virtual 3D model of the mold, the digital model having been created as set forth above. The entity may input the digital model into a 3D printer. The 3D printer then manufactures the mold using the digital model. 3D printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

In some instances, stereolithography (SLA), also known as optical fabrication solid imaging, is used to fabricate an SLA mold. In SLA, the mold is fabricated by successively printing thin layers of a photo-curable material (e.g., a polymeric resin) on top of one another. A platform rests in a bath of a liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured.

Materials such as a polyester, a co-polyester, a polycarbonate, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or combinations thereof, may be used to directly form the mold. The materials used for fabrication of the mold can be provided in an uncured form (e.g., as a liquid, resin, powder, etc.) and can be cured (e.g., by photopolymerization, light curing, gas curing, laser curing, crosslinking, etc.). The properties of the material before curing may differ from the properties of the material after curing.

Aligners may be formed from each mold, and when applied to the teeth of the patient may provide forces to move the patient’s teeth as dictated by the treatment plan. The shape of each aligner is unique and customized for a particular patient and a particular treatment stage. In an example, the aligners can be pressure formed or thermoformed over the molds. Each mold may be used to fabricate an aligner that will apply forces to the patient’s teeth at a particular stage of the orthodontic treatment. The aligners each have teeth-receiving cavities that receive and resiliently reposition the teeth in accordance with a particular treatment stage.

In one embodiment, a sheet of material is pressure formed or thermoformed over the mold. The sheet may be, for example, a sheet of plastic (e.g., an elastic thermoplastic, a sheet of polymeric material, etc.). To thermoform the shell over the mold, the sheet of material may be heated to a temperature at which the sheet becomes pliable. Pressure may concurrently be applied to the sheet to form the now pliable sheet around the mold. Once the sheet cools, it will have a shape that conforms to the mold. In one embodiment, a release agent (e.g., a non-stick material) is applied to the mold before forming the shell. This may facilitate later removal of the mold from the shell.

Additional information may be added to the aligner. The additional information may be any information that pertains to the aligner. Examples of such additional information includes a part number identifier, patient name, a patient identifier, a case number, a sequence identifier (e.g., indicating which aligner a particular liner is in a treatment sequence), a date of manufacture, a clinician name, a logo and so forth. For example, after an aligner is thermoformed, the aligner may be laser marked with a part number identifier (e.g., serial number, barcode, or the like). In some embodiments, the system may be configured to read (e.g., optically, magnetically, or the like) an identifier (barcode, serial number, electronic tag or the like) of the mold to determine the part number identifier associated with the aligner formed thereon. After determining the part number identifier, the system may then tag the aligner with the unique part number identifier. The part number identifier may be computer readable and may associate that aligner to a specific patient, to a specific stage in the treatment sequence, whether it’s an upper or lower shell, a digital model representing the mold the aligner was manufactured from and/or a digital file including a virtually generated digital model or approximated properties thereof of that aligner (e.g., produced by approximating the outer surface of the aligner based on manipulating the digital model of the mold, inflating or scaling projections of the mold in different planes, etc.). In some embodiments, the virtually generated digital model of the aligner or approximated properties thereof may be compared to a property (e.g., shape of the aligner) of the manufactured aligner determined from an image of the manufactured aligner for image based quality control.

After an aligner is formed over a mold for a treatment stage, that aligner is subsequently trimmed along a cutline (also referred to as a trim line) and the aligner may be removed from the mold. The processing logic may determine a cutline for the aligner. The determination of the cutline(s) may be made based on the virtual 3D model of the dental arch at a particular treatment stage, based on a virtual 3D model of the aligner to be formed over the dental arch, or a combination of a virtual 3D model of the dental arch and a virtual 3D model of the aligner. The location and shape of the cutline can be important to the functionality of the aligner (e.g., an ability of the aligner to apply desired forces to a patient’s teeth) as well as the fit and comfort of the aligner. For shells such as orthodontic aligners, orthodontic retainers and orthodontic splints, the trimming of the shell may play a role in the efficacy of the shell for its intended purpose (e.g., aligning, retaining or positioning one or more teeth of a patient) as well as the fit of the shell on a patient’s dental arch. For example, if too much of the shell is trimmed, then the shell may lose rigidity and an ability of the shell to exert force on a patient’s teeth may be compromised.

On the other hand, if too little of the shell is trimmed, then portions of the shell may impinge on a patient’s gums and cause discomfort, swelling, and/or other dental issues. Additionally, if too little of the shell is trimmed at a location, then the shell may be too rigid at that location. In some embodiments, the cutline may be a straight line across the aligner at the gingival line, below the gingival line, or above the gingival line. In some embodiments, the cutline may be a gingival cutline that represents an interface between an aligner and a patient’s gingiva. In such embodiments, the cutline controls a distance between an edge of the aligner and a gum line or gingival surface of a patient.

Each patient has a unique dental arch with unique gingiva. Accordingly, the shape and position of the cutline may be unique and customized for each patient and for each stage of treatment. For instance, the cutline is customized to follow along the gum line (also referred to as the gingival line). In some embodiments, the cutline may be away from the gum line in some regions and on the gum line in other regions. For example, it may be desirable in some instances for the cutline to be away from the gum line (e.g., not touching the gum) where the shell will touch a tooth and on the gum line (e.g., touching the gum) in the interproximal regions between teeth. Accordingly, it is important that the shell be trimmed along a predetermined cutline.

In some embodiments, a dental appliance may have multiple cutlines. A first or primary cutline may control a distance between an edge of the shell and a gum line of a patient. Additional cutlines may be for cutting slots, holes, or other shapes in the shell. For example, an additional cutline may be for removal of an occlusal surface of the shell, an additional surface of the shell, or a portion of the shell that, when removed, causes a hook to be formed that is usable with an elastic.

After cutline determination, the aligner may then be cut along the cutline (or cutlines) using markings and/or elements that were imprinted in the aligner. In some embodiments, the aligner may be manually cut by a technician using scissors, a bur, a cutting wheel, a scalpel, or any other cutting implement. In another embodiment, the aligner is cut along the cutline by a computer controlled trimming machine such as a CNC machine or a laser trimming machine. The computer controlled trimming machine may include a camera that is capable of identifying the cutline in the aligner. The computer controlled trimming machine may use images from a camera to determine a location of the cutline from markings in the aligner, and may control an angle and position of a cutting tool of the trimming machine to trim the aligner along the cutline using the identified markings.

Additionally, or alternatively, the aligner may include coordinate system reference marks usable to orient a coordinate system of the trimming machine with a predetermined coordinate system of the aligner. The trimming machine may receive a digital file with trimming instructions (e.g., that indicate positions and angles of a laser or cutting tool of the trimming machine to cause the trimming machine to trim the aligner along the cutline). By aligning the coordinate system of the trimming machine to the aligner, an accuracy of computer controlled trimming of the aligner at the cutline may be improved. The coordinate system reference marks may include marks sufficient to identify an origin and an x, y and z axis.

In some embodiments, a transparent 3D object may be directly fabricated based on a digital file using additive manufacturing techniques (also referred to herein as “3D printing”) as opposed to thermoformed over a 3D printed mold. For example, a orthodontic aligner may be directly 3D printed. To manufacture the 3D object, a shape of the object may be determined and designed using computer aided engineering (CAE) or computer aided design (CAD) programs. In some instances, stereolithography (SLA) may be used to fabricate the 3D printed object from a digital file containing or representing a 3D model of the transparent 3D object.

In some embodiments, transparent 3D objects may be produced using other additive manufacturing techniques. Other additive manufacturing techniques may include: (1) material jetting, in which material is jetted onto a build platform using either a continuous or drop on demand (DOD) approach; (2) binder jetting, in which alternating layers of a build material (e.g., a powder-based material) and a binding material (e.g., a liquid binder) are deposited by a print head; (3) fused deposition modeling (FDM), in which material is drawn through a nozzle, heated, and deposited layer by layer; (4) powder bed infusion, including but not limited to direct metal laser sintering (DMLS), electron beam melting (EBM), selective heat sintering (SHS), selective laser melting (SLM), and selective laser sintering (SLS); (5) sheet lamination, including but not limited to laminated object manufacturing (LOM) and ultrasonic additive manufacturing (UAM); and (6) directed energy deposition, including but not limited to laser engineering net shaping, directed light fabrication, direct metal deposition, and 3D laser cladding.

For both directly 3D printed transparent 3D objects (e.g., dental appliances), and transparent 3D objects (e.g., dental appliances) thermoformed over 3D printed molds, multiple different types of defects may occur, such as layering defects from the 3D printing process (e.g., surface defects, internal defects, interface defects, etc.), cut line defects, gingival line defects, deformation defects (e.g., warpage of the dental appliance, such as that caused by removing a dental appliance from a mold with excessive force), and so on. Any one or more of these types of defects may be detectable by an IBQC system as described in embodiments herein.

FIG. 6 illustrates a flow diagram for a method 600 of detecting a manufacturing defect in a transparent 3D object, in accordance with one embodiment. One or more operations of method 600 may be performed by a processing logic of a computing device. It should be noted that the method 600 may be performed for multiple unique transparent 3D objects. In one embodiment, the method 600 may be performed for each unique orthodontic aligner for each stage of a patient’s orthodontic treatment plan. The aligner may be a 3D printed aligner, or may have been formed by thermoforming a sheet of plastic over a 3D printed mold of a dental arch.

At block 602, a first illumination of a transparent 3D object (e.g., an orthodontic aligner or other transparent dental appliance) may be provided using a first light source. The first illumination may be provided by an imaging system (e.g., by the imaging system 106 of FIGS. 1A-B ) based on instructions from processing logic. In one embodiment, the first illumination may be provided by light emitting elements from a top view lighting system disposed beneath a transparent platform on which the transparent 3D object rests during imaging.

At block 604, one or more images of the transparent 3D object may be generated using a top view imaging device (e.g., a top view camera) based on instructions from processing logic. In one embodiment, the one or more images include a first image and a second image. The first image may include a representation of an ID (e.g., symbol sequence) on a distinct region or view of the transparent 3D object. In one embodiment, the first image was generated under particular lighting conditions that increase a clarity and/or contrast of laser markings (e.g., where the representation of the ID is a laser marking). In some embodiments, at block 606 processing logic processes the first image to determine an ID of the transparent 3D object. This may include performing optical content recognition (OCR) on the first image to identify a symbol sequence to determine the ID. The ID may be associated with the transparent 3D object depicted in the first image. The processing logic may determine a digital file associated with the ID. The digital file may include one or more properties associated with at least one surface of the transparent 3D object.

In some embodiments, the first image and/or a second image captured by the top view camera is processed to identify one or more defects. In some embodiments, the second image is captured using different camera settings of the top view camera and/or different illumination settings of the first lighting system. The first image and/or second image may be processed to determine whether the transparent 3D object has any defects. For example, the first image and/or second image may be processed to determine gross defects (e.g., deformations) in the transparent 3D object.

At block 610, processing logic provides a second illumination of the transparent 3D object using a plurality of second light sources. The plurality of second light sources may be components of a second lighting system, such as a side view lighting system (e.g., second lighting system 124 of FIGS. 1A-B), in embodiments. At block 612, a plurality of side view cameras each capture one or more images of the transparent 3D object, resulting in a plurality of side view images of the transparent 3D object that depict a plurality of different regions of the transparent 3D object. In some embodiments, the plurality of cameras capture side view images of the transparent 3D object simultaneously. Alternatively, the plurality of cameras may capture the side view images in sequence.

Each image of the plurality of side view images may depict a distinct region or view of the transparent 3D object (e.g., a different side of a dental appliance) and may be captured by a different side view camera. The transparent platform supporting the transparent 3D object and the side view cameras may all have fixed positions during the image capture process.

At block 614, processing logic processes the plurality of side view images to identify any defects in the transparent 3D object. In some embodiments, the images are processed by one or more AI model. In some embodiments, the images are processed using a rules-based logic. The AI model may be trained to receive an image of a transparent 3D object as an input, and to provide as an output an indication of one or more types of defects, locations of defects, and/or probabilities of defects. In one embodiment, the AI model outputs a classification that indicates whether or not a defect has been detected. In one embodiment, the AI model may identify multiple different types of defects, and indicate for each type of defect whether that type of defect has been identified in the image. For example, the output may include a vector having multiple elements, where each element may include a value representing a probability that the image contains a defect of a particular defect type. In some embodiments, the output is a probability of the transparent 3D object having a defect. In a further example, an output may indicate a 90% probability of an internal volume defect, a 15% probability of a surface defect, a 2% probability of an interface defect, a 5% probability of a line thickness defect, and an 8% chance of a delamination defect. Defect probabilities that are above a threshold (e.g., 80% probability, 90% probability, etc.) may be classified as defects. Defect probabilities that are below the threshold may be classified as defect-free. In some embodiments, the AI model outputs bounding boxes around identified defects. In some embodiments, the AI model performs semantic segmentation or instance segmentation, and outputs segmentation information identifying defects.

In one embodiment, in addition to identifying the presence of defects, the AI model also outputs coordinates associated with the identified defects. The coordinates may be x, y pixel locations in the input image. Processing logic may then mark the images with the coordinates of the defect in some embodiments. Additionally, processing logic may indicate a type of defect identified at the identified coordinates in embodiments. This may enable a user to quickly review and double check results of positive defect classifications.

In one embodiment, the AI model may output a confidence metric for each defect probability that it outputs. The confidence metric may indicate a confidence level associated with the output defect probability. If a confidence metric is low, this may indicate that there was insufficient detail and/or contrast in the image to accurately determine whether a defect exists. In some embodiments, the confidence metric output by the AI model is compared to a confidence threshold.

In some embodiments, processing logic determines properties of the transparent 3D object from a captured image and compares the determined properties to planned properties of the transparent 3D object as specified in a treatment plan or additional data associated with the transparent 3D object (e.g., as indicated in a 3D model of the transparent 3D object from the treatment plan). If the determined properties differ from the planned properties by more than a threshold amount, then one or more types of defects (e.g., cutline defects and/or deformation defects) may be identified.

At block 616, processing logic may output results of the defect detection. The results of defect detection may be output to a display of an IBQC system, may be stored in a data store, and/or may be transmitted to a remote computing device. The remote computing device may receive the results of defect detection, and may store the results and/or output the results to a display. In one embodiment, the AI model and/or other defect detection algorithms may output a defect rating for each defect or group of defects identified in one or more input image. The defect rating may rate a defect in accordance with the severity of the defect and/or the likelihood that the defect will later cause a problem. The defect rating may be based on a density or quantity of defects identified in the image as well as sizes or magnitudes of the defects and/or the types of defects.

If the transparent 3D object has defects, a severity of the defects may be compared to a defect threshold. If a combined severity of the defected detects exceeds a severity threshold, then the transparent 3D object may be flagged as having failed quality control and be identified as defective. In one embodiment, the failed transparent 3D object may be fixed to remove the manufacturing defect. In a further embodiment, the transparent 3D object may be prevented from being used further in a manufacturing process or shipped to a user. In another embodiment, the transparent 3D object may be scrapped and a replacement may be manufactured.

If the transparent 3D object has no defects, or a combined severity of detected defects is below a severity threshold, then the transparent 3D object may pass quality control and be identified as acceptable.

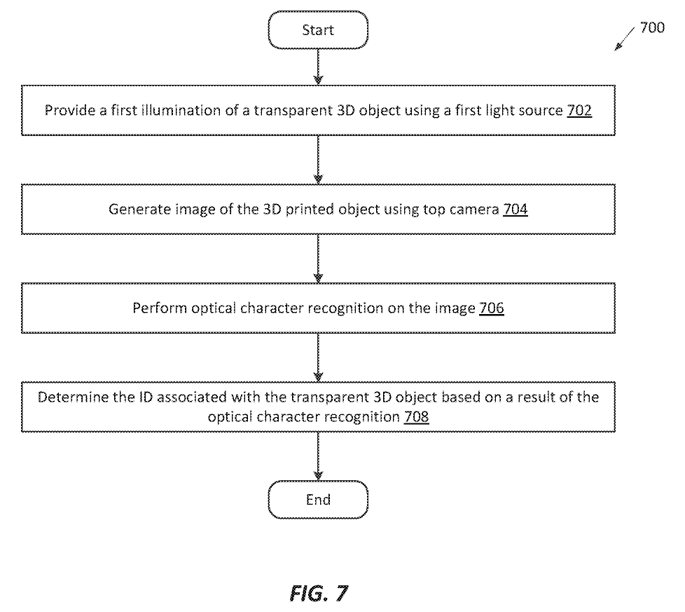

FIG. 7 illustrates a flow diagram for a method 700 of determining an ID associated with a transparent 3D object, in accordance with one embodiment. At block 702, a first illumination of a transparent 3D object may be provided using a first lighting system. At block 704, a top view image of the transparent 3D printed object may be generated using a top view camera. At block 706, OCR is performed on the image. The processing logic may process the image to identify a location of a symbol sequence in the image. The symbol sequence may contain letters, numbers, special symbols, punctuation symbols, etc. The processing logic may then perform OCR on the symbol sequence. The OCR may be performed using any known method, such as matrix matching, feature extraction, or a combination thereof. In one embodiment, the processing logic may apply one or more conversion operations to the image to more clearly process the symbol sequence. Conversion operations may include changing the resolution of the image, performing binarization of the image using certain parameters, correction of distortions, glare, or fuzziness, performing noise reduction operations, etc. These operations may be applied to the entire image or the portion of the image containing the identified symbol sequence.

In one embodiment, the symbol sequence may not be displayed entirely by the image generated by the imaging system. For example, the image may depict a distinct region or view of the transparent 3D object containing one half of the symbol sequence. In one embodiment, the processing logic may generate at least one additional image of the location of the symbol sequence. If the newly generated image includes the entire symbol sequence, the processing logic may process the image in accordance with the procedure described above. If the newly generated image depicts another half of the symbol sequence, processing logic may perform a stitching operation to generate a single image containing the symbol sequence. The processing logic then may perform the OCR according to the procedure described above.

At block 708, the ID associated with the transparent 3D object may be determined based on a result of the OCR. After the OCR is performed according to block 706, the processing logic may produce a first result containing a computer-readable version of the symbol sequence identified in the image. The processing logic may compare the first result to one or more transparent 3D object IDs (e.g., dental appliance IDs) to determine whether the first result corresponds to a known transparent 3D object ID. If the first result is not determined to correspond to a known transparent 3D object ID, the first result is rejected. In one embodiment, a second OCR operation may be performed on the image to generate a second result. In another embodiment, an OCR operation may be performed on a different image than the image that generated the first result in order to generate a second result. If the first or second result is determined to correspond to a known transparent 3D object identifier, the processing logic determines the first or second result is the ID associated with the transparent 3D object.

In another embodiment, a technician may manually input the ID associated with the transparent 3D object at the IBQC system using an interface. In another embodiment, a sorting system may sort a series of transparent 3D objects in a known order. The processing logic may retrieve the transparent 3D object order from the sorting system in order to know which of the transparent 3D objects are currently being processed and the order in which they arrived at the imaging system.

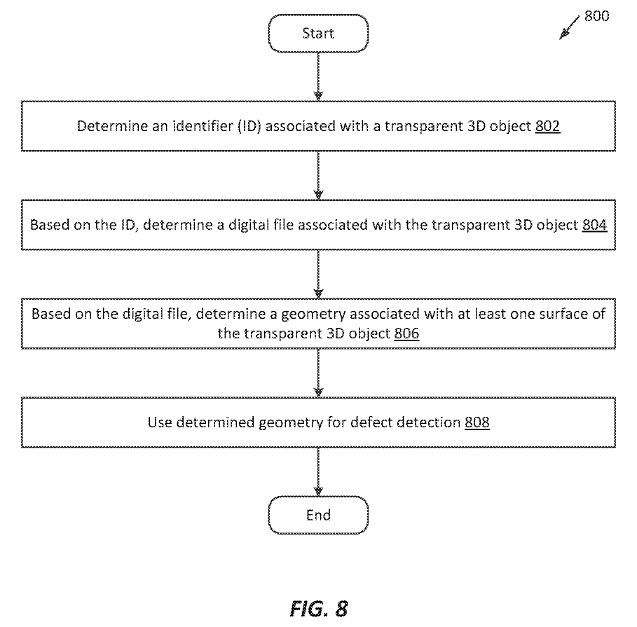

FIG. 8 illustrates a flow diagram for a method 800 of detecting a gross defect of a transparent 3D object, in accordance with one embodiment. In one embodiment, a gross defect on a mold of a dental arch used to form a dental appliance (e.g., an orthodontic aligner), or on a directly 3D printed dental appliance, may include arch variation, deformation, bend (compressed or expanded), cutline variations, webbing, trimmed attachments, missing attachments, burrs, flaring, power ridge issues, material breakage, short hooks, and so forth. At block 802, an ID associated with the transparent 3D object is determined. The ID may be determined using any of the ID determination methods described for the method depicted in FIG. 7.

At block 804, a digital file associated with the transparent 3D object may be determined. The digital file may be determined from a set of digital files. The digital file may be associated with the 3D object based on the ID. Each digital file of the set of digital files may include a digital model (e.g., a virtual 3D model) of the 3D object. In one embodiment, each digital file may include a digital model of a mold used to manufacture an aligner or other dental appliance. Each digital file may be for a unique, customized 3D object. In one embodiment, each digital file may be for a specific mold customized for a specific patient at a particular stage in the patient’s treatment plan.

In one embodiment, the transparent 3D object may be a directly fabricated (e.g., 3D printed) dental appliance. In one embodiment, the digital file associated with the ID may include a digital model of a first dental appliance. In some embodiments, the digital file is generated by the processing logic or is received from another source. The digital model of the first dental appliance may be dynamically generated by manipulating a digital model of a dental arch representing a state of the patient’s dentition at a stage of treatment. The digital model of the first dental appliance may be generated by enlarging the digital model of the dental arch into an enlarged digital model (e.g., by scaling or inflating a surface of the digital model). Further, generation of the digital model of the first dental appliance may include a projection of a cutline onto the enlarged digital model, virtually cutting the enlarged digital model along the cutline to create a cut enlarged digital model, and selecting the outer surface of the cut enlarged digital model. In one embodiment, the digital model of the first dental appliance comprises an outer surface of the first dental appliance, but does not necessarily have a thickness and/or does not comprise an inner surface of the first aligner, though it may include a thickness or inner surface in other embodiments.

In one embodiment, the digital file may include a virtual 3D model of a mold that is used to manufacture the first dental appliance. In one embodiment, the digital file may include multiple files associated with the first dental appliance, where the multiple files include a first digital file that comprises a digital model of the mold and a second digital file comprises a digital model of the first dental appliance. Alternatively, a single digital file may include both a digital model of the mold and a digital model of the first dental appliance.

At block 806, the processing logic may determine a geometry or shape associated with at least one surface of the transparent 3D object based on the digital file. In one embodiment, processing logic determines a first silhouette for the first 3D object from the first digital file. In one embodiment, the first silhouette is included in the digital file for the first 3D object. In one embodiment, the first silhouette is based on a projection of the digital model of the first 3D object onto a plane defined by an image of the first 3D object (e.g., an image generated by the top view camera or a side view camera). In one embodiment, the first silhouette is based on a manipulation of a digital model the first 3D object. For example, in some embodiments, the first silhouette may be based on a projection of the digital model of the 3D object onto the plane defined by the image of the 3D object. In such instances, the projection of the 3D object may be scaled or otherwise adjusted to approximate a projection of a 3D object from a particular point of view (e.g., the point of view of the top view camera or side view camera). In a further embodiment, the first silhouette may be based on a manipulation of the digital model, wherein the manipulation causes an outer surface of the digital model to have an approximate shape of the 3D object, and is further based on a projection of the outer surface of the digital model onto the surface defined by the image of the 3D object. In some embodiments, the first silhouette may be determined from an approximated outer surface of the 3D object. In some embodiments, the first silhouette may include a first shape of a projection of the outer surface of the first 3D object onto a plane defined by an image of the 3D object.

At block 808, processing logic may use the determined geometry of the transparent 3D object and the captured images for defect detection. In one embodiment, processing logic determines a second silhouette of the transparent 3D object from at least one image of the transparent 3D object. An image of the transparent 3D object may define a plane. The second silhouette may include an outline of a second shape of the transparent 3D object as projected onto the plane defined by the image. The second silhouette may be determined directly from one or more images (e.g., top view, side view, etc.). In one embodiment, a contour of the second shape is drawn from the image to form the second silhouette (e.g., based on performing edge detection on the image to identify the contour).

Processing logic may compare the first silhouette to the second silhouette. The processing logic may identify, based on comparing the first silhouette to the second silhouette, one or more differences between the first silhouette and the second silhouette. In some embodiments, the processing logic may identify the one or more differences by determining one or more regions where the first shape of the first silhouette and a second shape of the second silhouette do not match. The processing logic may further determine the differences of the regions (e.g., at least one of a thickness of the one or more regions or an area of the one or more regions).

In some embodiments, processing logic inputs an image of the transparent 3D object and an associated projection of the digital 3D model of the transparent 3D object onto an image plane of the image into a trained AI model. The trained AI model may then output any perceived defects that are based on differences between the transparent 3D object in the image and in the projection onto the image plane.

In one embodiment, processing logic may generate a difference metric between the first silhouette and the second silhouette based on the comparison and/or based on an output of the AI model. The difference metric may include a numerical representation of the differences between the expected geometry or shape of the transparent 3D object and the actual geometry of shape of the transparent 3D object (e.g., between the first silhouette and the second silhouette).

The processing logic may determine whether the difference metric exceeds a difference threshold. The difference threshold may be any suitable configurable amount (e.g., difference greater than three millimeters (mm), 5mm, 10mm, a region having an area greater than one hundred mm squared, etc.). If the difference metric exceeds the difference threshold, the processing logic may classify the 3D object as having a gross defect. In one embodiment, the 3D object classified as having a gross defect may be further classified as deformed. If it is determined that the difference metric does not exceed the difference threshold, the processing logic may determine that the shape of the 3D object does not have a gross defect. In one embodiment, a transparent 3D object with a gross defect may be fixed so as to remove the gross defect. In another embodiment, a transparent 3D object with a gross defect may be scrapped and a replacement transparent 3D object may be manufactured prior to use or shipment of the transparent 3D object.

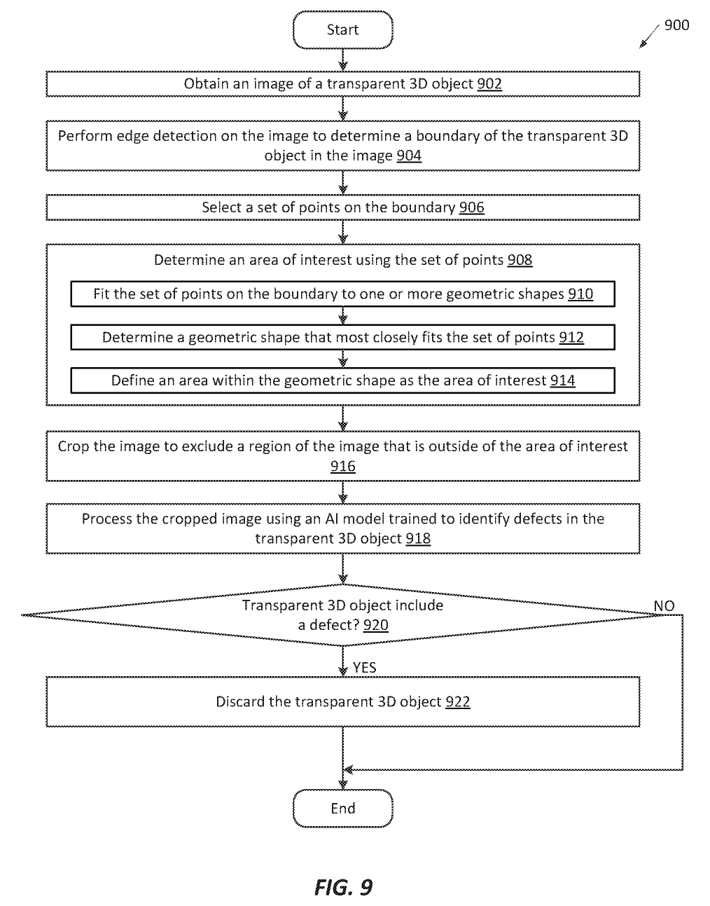

FIG. 9 illustrates a flow diagram for a method 900 of processing an image captured by IBQC system to detect a defect, in accordance with one embodiment. In one embodiment, the method 900 may be performed for each unique dental appliance associated with a treatment plan (e.g., orthodontic aligners of an orthodontic treatment plan).

At block 902, an image of a 3D object is obtained by the processing logic. The image may have been generated as one of a plurality of images by IBQC system 100, for example. In one embodiment, the image may be generated by a top view camera or a side view camera. Each image of the plurality of images may depict a distinct region or view of the transparent 3D object.

At block 904, edge detection (or other differencing process) is performed on the image to determine a boundary of the transparent 3D object in the image. The edge detection may include application of an automated image processing function, such as an edge detection algorithm. One example edge detection operation or algorithm that may be used is multiscale combinatorial grouping. Other examples of edge detection algorithms that may be used are the Canny edge detector, the Deriche edge detector, first order and second order differential edge detectors (e.g., a second order Gaussian derivative kernel), a Sobel operator, a Prewitt operator, a Roberts cross operator, and so on. A segmentation operation (e.g., a tooth segmentation operation) may also be performed on the image instead of, or in addition to, the edge detection. In one embodiment, a segmentation operation may be applied to segment the transparent 3D object into separate objects, so as to highlight distinct regions or views of the transparent 3D object depicted in the image. In one embodiment, a combination of multiple edge detection algorithms and/or segmentation algorithms is used for edge detection.

At block 906, a set of points may be selected on the boundary. In one embodiment, one portion of the image within the boundary may include more contrast than another portion of the image within the boundary. In such embodiment, the set of points may be selected on the boundary towards the portion of the image with more contrast.

At block 908, an area of interest is determined using the set of points and/or the boundary. In one embodiment, the processing logic may generate one or more shapes that correspond to the set of points and/or the boundary.

In one embodiment, the processing logic may further define the area of interest. The processing logic may identify a portion of the image within the geometric shape to be the area of interest. In one embodiment, the processing logic may determine the area of interest includes at least a minimum height and/or width.

At block 916, the image may be cropped to exclude the region of the image outside of the area of interest.

At block 918, the cropped image (or uncropped image) may be processed using an AI model (e.g., an artificial neural network) and/or other algorithms to identify manufacturing defects on the transparent 3D object. For example, one or more image processing operations may be performed on the cropped image (or the uncropped image), and a result of the image processing operations may be compared to a set of defined rules or other image data.

In one embodiment, the machine learning model (or set of defined rules) may determine whether a particular type of layering defect is present (e.g., by identifying a plurality of lines present within the area of interest), whether a deformation defect is present within the area of interest, whether a cut line defect is present within the area of interest, and/or whether other types of defects are present. In an example, a plurality of lines may result from the manufacturing process (e.g., SLA) used to fabricate the transparent 3D object. The set of defined rules may include an acceptable threshold number of lines that should be present in an area having a similar dimension to the area of interest. The processing logic may determine whether the number of lines within the area of interest is within the acceptable threshold. If the processing logic determines that the number of lines is not within the acceptable threshold, the machine learning model may indicate the area of interest as containing a defect. The processing logic may additionally determine the severity of the defect and the likelihood that the defect could cause significant deformations. If the processing logic determines that the defect is within an acceptable threshold, the processing logic may indicate the area of interest as not containing the particular type of defect.

The AI model may be trained to identify each of the above discussed types of defects based on a training dataset with labeled images of transparent 3D objects that are defect free as well as labeled images of transparent 3D objects that include these types of defects. Additionally, the AI model may be trained to identify other types of defects (e.g., layering defects). For example, the AI model may determine whether debris, air bubbles (voids) or holes (pitting) are present within the area of interest. If debris or holes are present, the AI model may indicate the area of interest as containing a layering defect (e.g., a surface defect or an interface defect), and may optionally indicate the type of layering defect and/or the coordinates on the image where a defect (e.g., a layering defect, cutline defect, deformation, etc.) was detected. The AI model may additionally determine a severity of the defect and the likelihood that the defect could cause problems (e.g., prevent the a dental appliance from fitting a patient comfortably).

The AI model may generate an output to be processed by the processing logic. In one embodiment, the output to the AI model may include a probability that the image includes a defect. In one embodiment, the output includes, for each type of defect that the AI model has been trained to detect, the probability that a defect of that type is included in the image. In another embodiment, the output of the AI model may include a defect rating indicating the severity of a defect identified in the image. In another embodiment, the output of the AI model may include an identification of a location within the image where a defect was identified. The output may further include a highlight of the location of the defect in the image.

The AI model may be composed of a single level of linear or non-linear operations (e.g., a support vector machine (SVM) or a single level neural network) or may be a deep neural network that is composed of multiple levels of non-linear operations. Examples of deep networks and neural networks include convolutional neural networks and/or recurrent neural networks with one or more hidden layers. Some neural networks may be composed of interconnected nodes, where each node receives input from a previous node, performs one or more operations, and sends the resultant output to one or more other connected nodes for future processing.

Convolutional neural networks include architectures that may provide efficient image recognition. Convolutional neural networks may include several convolutional layers and subsampling layers that apply filters to portions of the image of the text to detect certain features (e.g., defects). That is, a convolutional neural network includes a convolution operation, which multiplies each image fragment by filters (e.g., matrices) element-by-element and sums the results in a similar position in an output image.

Recurrent neural networks may propagate data forwards, and also backwards, from later processing stages to earlier processing stages. Recurrent neural networks include functionality to process information sequences and store information about previous computations in the context of a hidden layer. As such, recurrent neural networks may have a “memory”.

Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize that the image contains a face or define a bounding box around teeth in the image. Notably, a deep learning process can learn which features to optimally place in which level on its own. The "deep" in "deep learning" refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

The machine learning model that identifies defects from images of transparent 3D objects may be trained using a training dataset. Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available. The training dataset may include many images of transparent 3D objects. Each image may include a label or target for that image. The label or target may indicate whether the image includes a defect, a type of defect, a location of one or more defects, a severity of defect, and/or other information.

In one embodiment, training of the machine learning model is ongoing. Accordingly, as new images are generated, the machine learning model may be applied to identify defects in those images. In some instances a part may be based on the output of the machine learning model, but the part may ultimately fail due to undetected defects. This information may be added to the images that were processed, and those images may be fed back through the machine learning model in an updated learning process to further teach the machine learning model and reduce future false negatives.

At block 920, it is determined by the processing logic whether the transparent 3D object includes a defect, and/or whether the transparent 3D object includes one or more defects that will adversely affect use of the transparent 3D object for its intended purpose. The processing logic may evaluate the AI model output for the image, as well as all other images of the plurality of images in accordance with methods described above. In one embodiment, the output generated by the AI model may include the defect rating for each defect identified in each image of the plurality of images. The processing logic may compare the output of the AI model (e.g., the defect ratings) to a defect threshold. In one embodiment, the processing logic may compare the output for each image to the defect threshold. In another embodiment, the processing logic may generate an overall combined defect rating for the plurality of images and compare the overall combined defect rating to the defect threshold. If the output is above the defect threshold, the processing logic may determine that a defect is identified in the images associated with the transparent 3D object, and the method 900 may continue to block 922. If the output is below the defect threshold, the processing logic may determine that a manufacturing defect is not identified in the transparent 3D object, and the method 900 may terminate.

If it is determined by the processing logic that the transparent 3D object includes a defect, at block 922, the transparent 3D object may be discarded. In one embodiment, the transparent 3D object may be fixed to remove the defect. In another embodiment, the transparent 3D object may be scrapped and a replacement transparent 3D object may be manufactured.

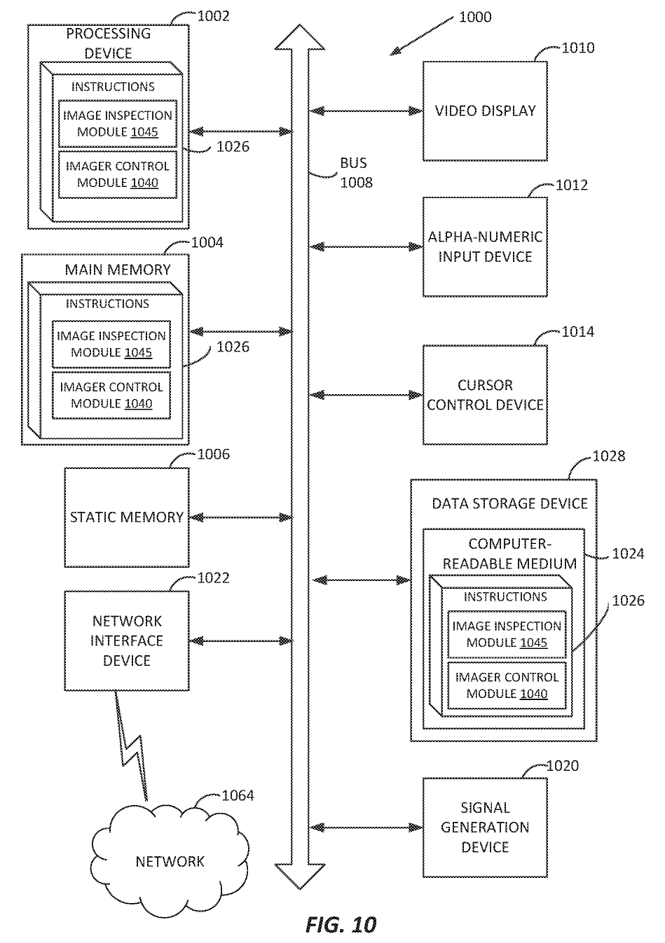

FIG. 10 illustrates a diagrammatic representation of a machine in the example form of a computing device 1000 within which a set of instructions, for causing the machine to perform any one or more of the methodologies discussed with reference to the methods of FIGS. 6-9. In alternative embodiments, the machine may be connected (e.g., networked) to other machines in a Local Area Network (LAN), an intranet, an extranet, or the Internet. For example, the machine may be networked to a rapid prototyping apparatus such as a 3D printer or SLA apparatus. In another example, the machine may be networked to, directly connected to, or a component of, an IBQC system. In one embodiment, the computing device 1000 corresponds to the computing device 105 of FIGS. 1A - B. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 1000 includes a processing device 1002, a main memory 1004 (e.g., read only memory (ROM), flash memory, dynamic random access memory (DRAM) such as synchronous DRAM (SDRAM), etc.), a static memory 1006 (e.g., flash memory, static random access memory (SRAM), etc.), and a secondary memory (e.g., a data storage device 1028), which communicate with each other via a bus 1008.

Processing device 1002 represents one or more general-purpose processors such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. Processing device 1002 is configured to execute the processing logic (instructions 1026) for performing operations and steps discussed herein.

The computing device 1000 may further include a network interface device 1022 for communicating with a network 1064. The computing device 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1020 (e.g., a speaker).

The data storage device 1028 may include a machine-readable storage medium (or more specifically a non-transitory computer-readable storage medium) 1024 on which is stored one or more sets of instructions 1026 embodying any one or more of the methodologies or functions described herein. A non-transitory storage medium refers to a storage medium other than a carrier wave. The instructions 1026 may also reside, completely or at least partially, within the main memory 1004 and/or within the processing device 1002 during execution thereof by the computer device 1000, the main memory 1004 and the processing device 1002 also constituting computer-readable storage media.

The computer-readable storage medium 1024 may also be used to an image inspection module 145 and/or imager control module 140 as described herein above, which may perform one or more of the operations of methods described with reference to FIGS. 6-9. The computer readable storage medium 1024 may also store a software library containing methods that call an image inspection module 1045 and/or imager control module 1040, which may performed any of the above mentioned operations. While the computer-readable storage medium 1024 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media, and other non-transitory computer-readable media.

As discussed herein above, in some embodiments, the IBQC system 100 of FIGS. 1A-B may be used to perform automated defect detection of molds of dental arches used to manufacture aligners and/or to perform automated defect detection of directly printed aligners.

FIG. 11 illustrates an exemplary transparent tooth repositioning appliance or aligner 1200 that can be worn by a patient in order to achieve an incremental repositioning of individual teeth 1202 in the jaw. The appliance can include a shell (e.g., a continuous polymeric shell or a segmented shell) having teeth-receiving cavities that receive and resiliently reposition the teeth. An aligner (also referred to as an appliance) or portion(s) thereof may be indirectly fabricated using a physical model of teeth. For example, an appliance (e.g., polymeric appliance) can be formed using a physical model of teeth and a sheet of suitable layers of polymeric material. A “polymeric material,” as used herein, may include any material formed from a polymer. A “polymer,” as used herein, may refer to a molecule composed of repeating structural units connected by covalent chemical bonds often characterized by a substantial number of repeating units (e.g., equal or greater than 3 repeating units, optionally, in some embodiments equal to or greater than 10 repeating units, in some embodiments greater or equal to 30 repeating units) and a high molecular weight (e.g., greater than or equal to 10,000 Da, in some embodiments greater than or equal to 50,000 Da or greater than or equal to 100,000 Da). Polymers are commonly the polymerization product of one or more monomer precursors. The term polymer includes homopolymers, or polymers consisting essentially of a single repeating monomer subunit. The term polymer also includes copolymers which are formed when two or more different types of monomers are linked in the same polymer. Useful polymers include organic polymers or inorganic polymers that may be in amorphous, semi-amorphous, crystalline or semi-crystalline states. Polymers may include polyolefins, polyesters, polyacrylates, polymethacrylates, polystyrenes, polypropylenes, polyethylenes, polyethylene terephthalates, poly lactic acid, polyurethanes, epoxide polymers, polyethers, poly(vinyl chlorides), polysiloxanes, polycarbonates, polyamides, poly acrylonitriles, polybutadienes, poly(cycloolefins), and copolymers. The systems and/or methods provided herein are compatible with a range of plastics and/or polymers. Accordingly, this list is not inclusive, but rather is exemplary. The plastics can be thermosets or thermoplastics. The plastic may be thermoplastic.

Examples of materials applicable to the embodiments disclosed herein include, but are not limited to, those materials described in the following Provisional patent applications filed by Align Technology: "MULTIMATERIAL ALIGNERS," US Prov. App. Ser. No. 62/189,259, filed Jul. 7, 2015; "DIRECT FABRICATION OF ALIGNERS WITH INTERPROXIMAL FORCE COUPLING", US Prov. App. Ser. No. 62/189,263, filed Jul.7, 2015; "DIRECT FABRICATION OF ORTHODONTIC APPLIANCES WITH VARIABLE PROPERTIES," US Prov. App. Ser. No. 62/189 291, filed Jul. 7, 2015; "DIRECT FABRICATION OF ALIGNERS FOR ARCH EXPANSION", US Prov. App. Ser. No. 62/189,271, filed Jul. 7, 2015; "DIRECT FABRICATION OF ATTACHMENT TEMPLATES WITH ADHESIVE," US Prov. App. Ser. No. 62/189,282, filed Jul. 7, 2015; "DIRECT FABRICATION CROSS-LINKING FOR PALATE EXPANSION AND OTHER APPLICATIONS", US Prov. App. Ser. No. 62/189,301, filed Jul. 7, 2015; "SYSTEMS, APPARATUSES AND METHODS FOR DENTAL APPLIANCES WITH INTEGRALLY FORMED FEATURES", US Prov. App. Ser. No. 62/189,312, filed Jul. 7, 2015; "DIRECT FABRICATION OF POWER ARMS", US Prov. App. Ser. No. 62/189,317, filed Jul. 7, 2015; "SYSTEMS, APPARATUSES AND METHODS FOR DRUG DELIVERY FROM DENTAL APPLIANCES WITH INTEGRALLY FORMED RESERVOIRS", US Prov. App. Ser. No. 62/189,303, filed Jul. 7, 2015; "DENTAL APPLIANCE HAVING ORNAMENTAL DESIGN", US Prov. App. Ser. No. 62/189,318, filed Jul. 7, 2015; "DENTAL MATERIALS USING THERMOSET POLYMERS," US Prov. App. Ser. No. 62/189,380, filed Jul. 7, 2015; "CURABLE COMPOSITION FOR USE IN A HIGH TEMPERATURE LITHOGRAPHY-BASED PHOTOPOLYMERIZATION PROCESS AND METHOD OF PRODUCING CROSSLINKED POLYMERS THEREFROM," US Prov. App. Ser. No. 62/667,354, filed May 4, 2018; "POL YMERIZABLE MONOMERS AND METHOD OF POLYMERIZING THE SAME," US Prov. App. Ser. No. 62/667,364, filed May 4, 2018; and any conversion applications thereof (including publications and issued patents), including any divisional, continuation, or continuation-in-part thereof.

The appliance 1200 can fit over all teeth present in an upper or lower jaw, or less than all of the teeth. The appliance can be designed specifically to accommodate the teeth of the patient (e.g., the topography of the tooth-receiving cavities matches the topography of the patient’s teeth), and may be fabricated based on positive or negative models of the patient’s teeth generated by impression, scanning, and the like. Alternatively, the appliance can be a generic appliance configured to receive the teeth, but not necessarily shaped to match the topography of the patient’s teeth. In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved an also serve as a base or anchor for holding the appliance in place over the teeth. In some cases, however, it may be desirable or necessary to provide individual attachments or other anchoring elements 1204 on teeth 1202 with corresponding receptacles or apertures 1206 in the appliance 1200 so that the appliance can apply a selected force on the tooth. Exemplary appliances, including those utilized in the Invisalign® System, are described in numerous patents and patent applications assigned to Align Technology, Inc. including, for example, in U.S. Patent Nos. 6,450,807, and 5,975,893, as well as on the company’s website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Patent Nos. 6,309,215 and 6,830,450.

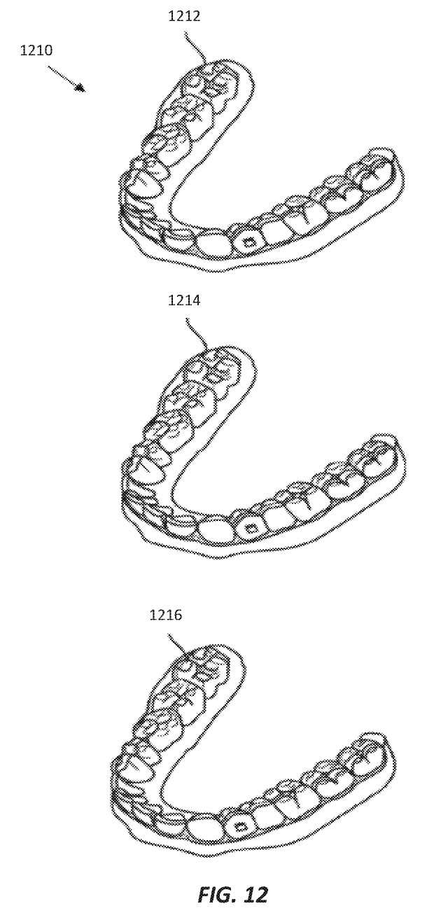

FIG. 12 illustrates a tooth repositioning system 1210 including a plurality of appliances 1212, 1214, and 1216. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient’s teeth can be progressively repositioned from an initial tooth arrangement to a target tooth arrangement by placing a series of incremental position adjustment appliances over the patient’s teeth. For example, the tooth repositioning system 1210 can include a first appliance 1212 corresponding to an initial tooth arrangement, one or more intermediate appliances 1214 corresponding to one or more intermediate arrangements, and a final appliance 1216 corresponding to a target arrangement. A target tooth arrangement can be a planned final tooth arrangement selected for the patient’s teeth at the end of all planned orthodontic treatment. Alternatively, a target arrangement can be one of some intermediate arrangements for the patient’s teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient’s teeth that follows one or more incremental repositioning stages. Likewise, an initial tooth arrangement can be any initial arrangement for the patient’s teeth that is followed by one or more incremental repositioning stages.

In some embodiments, the appliances 1212, 1214, 1216, or portions thereof, can be produced using indirect fabrication techniques, such as thermoforming over a positive or negative mold, which may be inspected using the methods and systems described herein above. Indirect fabrication of an orthodontic appliance can involve producing a positive or negative mold of the patient’s dentition in a target arrangement (e.g., by rapid prototyping, milling, etc.) and thermoforming one or more sheets of material over the mold in order to generate an appliance shell.

In an example of indirect fabrication, a mold of a patient’s dental arch may be fabricated from a digital model of the dental arch, and a shell may be formed over the mold (e.g., by thermoforming a polymeric sheet over the mold of the dental arch and then trimming the thermoformed polymeric sheet). The fabrication of the mold may be formed by a rapid prototyping machine (e.g., a SLA 3D printer). The rapid prototyping machine may receive digital models of molds of dental arches and/or digital models of the appliances 1212, 1214, 1216 after the digital models of the appliances 1212, 1214, 1216 have been processed by processing logic of a computing device. The processing logic may include hardware (e.g., circuitry, dedicated logic, programming logic, microcode, etc.), software (e.g., instructions executed by a processing device), firmware, or a combination thereof.

To manufacture the molds, a shape of a dental arch for a patient at a treatment stage is determined based on a treatment plan. In the example of orthodontics, the treatment plan may be generated based on an intraoral scan of a dental arch to be molded. The intraoral scan of the patient’s dental arch may be performed to generate a three dimensional (3D) virtual model of the patient’s dental arch (mold). For example, a full scan of the mandibular and/or maxillary arches of a patient may be performed to generate 3D virtual models thereof. The intraoral scan may be performed by creating multiple overlapping intraoral images from different scanning stations and then stitching together the intraoral images to provide a composite 3D virtual model. In other applications, virtual 3D models may also be generated based on scans of an object to be modeled or based on use of computer aided drafting technologies (e.g., to design the virtual 3D mold). Alternatively, an initial negative mold may be generated from an actual to be modeled (e.g., a dental impression or the like). The negative mold may then be scanned to determine a shape of a positive mold that will be produced.

Once the virtual 3D model of the patient’s dental arch is generated, a dental practitioner may determine a desired treatment outcome, which includes final positions and orientations for the patient’s teeth. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model will be different. The original virtual 3D model, the final virtual model 3D model and each intermediate virtual 3D model is unique and customized to the patient.

Accordingly, multiple different virtual 3D models (digital designs) of a dental arch may be generated for a single patient. A first virtual 3D model may be a unique model of a patient’s dental arch and/or teeth as they presently exist, and a final virtual 3D may be a model of the patient’s dental arch and/or teeth after correction of one or more teeth and/or a jaw. Multiple intermediate virtual 3D models may be modeled, each of which may be incrementally different from previous virtual 3D models.

Each virtual 3D model of a patient’s dental arch may be used to generate customized physical mold of the dental arch at a particular stage of treatment. The shape of the mold may be at least in part based on the shape of the virtual 3D model for that treatment stage. The virtual 3D model may be represented in a file such as a computer aided drafting (CAD) file or a 3D printable file such as a stereolithography (STL) file. The virtual 3D model for the mold may be sent to a third party (e.g., clinician office, laboratory, manufacturing facility or other entity). The virtual 3D model may include instructions that will control a fabrication system or device in order to produce the mold with specific geometries.

A clinician office, laboratory, manufacturing facility or other entity may receive the virtual 3D model of the mold, the digital model having been created as set forth above. The entity may input the digital model into a rapid prototyping machine. The rapid prototyping machine then manufactures the mold using the digital model. One example of a rapid prototyping manufacturing machine is a 3D printer. 3D printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

In some instances SLA is used to fabricate an SLA mold. In SLA, the mold is fabricated by successively printing thin layers of a photo-curable material (e.g., a polymeric resin) on top of one another. A platform rests in a bath of liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured.

Materials such as polyester, a co-polyester, a polycarbonate, a thermopolymeric polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermopolymeric elastomer (TPE), a thermopolymeric vulcanizate (TPV) elastomer, a polyurethane elastomer, a block copolymer elastomer, a polyolefin blend elastomer, a thermopolymeric co-polyester elastomer, a thermopolymeric polyamide elastomer, or combinations thereof, may be used to directly form the mold. The materials used for fabrication of the mold can be provided in an uncured form (e.g., as a liquid, resin, powder, etc.) and can be cured (e.g., by photopolymerization, light curing, gas curing, laser curing, crosslinking, etc.). The properties of the material before curing may differ from the properties of the material after curing.

After the mold is generated, it may be inspected using the systems and/or methods described herein above. If the mold passes the inspection, then it may be used to form an appliance (e.g., an aligner).

Appliances may be formed from each mold and when applied to the teeth of the patient, may provide forces to move the patient’s teeth as dictated by the treatment plan. The shape of each appliance is unique and customized for a particular patient and a particular treatment stage. In an example, the appliances 1212, 1214, and 1216 can be pressure formed or thermoformed over the molds. Each mold may be used to fabricate an appliance that will apply forces to the patient’s teeth at a particular stage of the orthodontic treatment. The appliances 1212, 1214, and 1216 each have teeth-receiving cavities that receive and resiliently reposition the teeth in accordance with a particular treatment stage.

In one embodiment, a sheet of material is pressure formed or thermoformed over the mold. The sheet may be, for example, a sheet of polymeric (e.g., an elastic thermopolymeric, a sheet of polymeric material, etc.). To thermoform the shell over the mold, the sheet of material may be heated to a temperature at which the sheet becomes pliable. Pressure may concurrently be applied to the sheet to form the now pliable sheet around the mold. Once the sheet cools, it will have a shape that conforms to the mold. In one embodiment, a release agent (e.g., a non-stick material) is applied to the mold before forming the shell. This may facilitate later removal of the mold from the shell.

Additional information may be added to the appliance. The additional information may be any information that pertains to the aligner. Examples of such additional information includes a part number identifier, patient name, a patient identifier, a case number, a sequence identifier (e.g., indicating which aligner a particular liner is in a treatment sequence), a date of manufacture, a clinician name, a logo and so forth. For example, after an appliance is thermoformed, the aligner may be laser marked with a part number identifier (e.g., serial number, barcode, or the like). In some embodiments, the system may be configured to read (e.g., optically, magnetically, or the like) an identifier (barcode, serial number, electronic tag or the like) of the mold to determine the part number associated with the aligner formed thereon. After determining the part number identifier, the system may then tag the aligner with the unique part number identifier. The part number identifier may be computer readable and may associate that aligner to a specific patient, to a specific stage in the treatment sequence, whether it is an upper or lower shell, a digital model representing the mold the aligner was manufactured from and/or a digital file including a virtually generated digital model or approximated properties thereof of that aligner (e.g., produced by approximating the outer surface of the aligner based on manipulating the digital model of the mold, inflating or scaling projections of the mold in different planes, etc.).

After an appliance is formed over a mold for a treatment stage, that appliance is subsequently trimmed along a cutline (also referred to as a trim line) and the appliance may be removed from the mold. The processing logic may determine a cutline for the appliance. The determination of the cutline(s) may be made based on the virtual 3D model of the dental arch at a particular treatment stage, based on a virtual 3D model of the appliance to be formed over the dental arch, or a combination of a virtual 3D model of the dental arch and a virtual 3D model of the appliance. The location and shape of the cutline can be important to the functionality of the appliance (e.g., an ability of the appliance to apply desired forces to a patient’s teeth) as well as the fit and comfort of the appliance. For shells such as orthodontic appliances, orthodontic retainers and orthodontic splints, the trimming of the shell may play a role in the efficacy of the shell for its intended purpose (e.g., aligning, retaining or positioning one or more teeth of a patient) as well as the fit on a patient’s dental arch. For example, if too much of the shell is trimmed, then the shell may lose rigidity and an ability of the shell to exert force on a patient’s teeth may be compromised. When too much of the shell is trimmed, the shell may become weaker at that location and may be a point of damage when a patient removes the shell from their teeth or when the shell is removed from the mold. In some embodiments, the cut line may be modified in the digital design of the appliance as one of the corrective actions taken when a probable point of damage is determined to exist in the digital design of the appliance.

On the other hand, if too little of the shell is trimmed, then portions of the shell may impinge on a patient’s gums and cause discomfort, swelling, and/or other dental issues. Additionally, if too little of the shell is trimmed at a location, then the shell may be too rigid at that location. In some embodiments, the cutline may be a straight line across the appliance at the gingival line, below the gingival line, or above the gingival line. In some embodiments, the cutline may be a gingival cutline that represents an interface between an appliance and a patient’s gingiva. In such embodiments, the cutline controls a distance between an edge of the appliance and a gum line or gingival surface of a patient.

Each patient has a unique dental arch with unique gingiva. Accordingly, the shape and position of the cutline may be unique and customized for each patient and for each stage of treatment. For instance, the cutline is customized to follow along the gum line (also referred to as the gingival line). In some embodiments, the cutline may be away from the gum line in some regions and on the gum line in other regions. For example, it may be desirable in some instances for the cutline to be away from the gum line (e.g., not touching the gum) where the shell will touch a tooth and on the gum line (e.g., touching the gum) in the interproximal regions between teeth. Accordingly, it is important that the shell be trimmed along a predetermined cutline.

In some embodiments, the dental (e.g., orthodontic) appliances herein (or portions thereof) can be produced using direct fabrication, such as additive manufacturing techniques (also referred to herein as “3D printing) or subtractive manufacturing techniques (e.g., milling). In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances 1212, 1214, and 1216. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances 1212, 1214, and 1216 can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances 1212, 1214, and 1216 can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances 1212, 1214, and 1216. In some embodiments, material jetting involves jetting or extruding one or more materials onto a build surface in order to form successive layers of the object geometry.

In some embodiments, the direct fabrication methods provided herein build up the object geometry in a layer-by-layer fashion, with successive layers being formed in discrete build steps. Alternatively or in combination, direct fabrication methods that allow for continuous build-up of an object geometry can be used, referred to herein as “continuous direct fabrication.” Various types of continuous direct fabrication methods can be used. As an example, in some embodiments, the appliances 1212, 1214, and 1216 are fabricated using “continuous liquid interphase printing,” in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Patent No. 7,892,474, the disclosure of which is incorporated herein by reference in its entirety.

In another example, a continuous direct fabrication method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

The direct fabrication approaches provided herein are compatible with a wide variety of materials, including but not limited to one or more of the following: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, a thermoset material, or combinations thereof. The materials used for direct fabrication can be provided in an uncured form (e.g., as a liquid, resin, powder, etc.) and can be cured (e.g., by photopolymerization, light curing, gas curing, laser curing, crosslinking, etc.) in order to form an orthodontic appliance or a portion thereof. The properties of the material before curing may differ from the properties of the material after curing. Once cured, the materials herein can exhibit sufficient strength, stiffness, durability, biocompatibility, etc. for use in an orthodontic appliance. The post-curing properties of the materials used can be selected according to the desired properties for the corresponding portions of the appliance.

In some embodiments, relatively rigid portions of the orthodontic appliance can be formed via direct fabrication using one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and/or a polytrimethylene terephthalate.

In some embodiments, relatively elastic portions of the orthodontic appliance can be formed via direct fabrication using one or more of the following materials: a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, and/or a thermoplastic polyamide elastomer.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every nth build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials from distinct material supply sources in order to fabricate an object from a plurality of different materials. Such methods are described in U.S. Patent No. 6,749,414, the disclosure of which is incorporated herein by reference in its entirety. Alternatively or in combination, a multi-material direct fabrication method can involve forming an object from multiple materials in a plurality of sequential manufacturing steps. For instance, a first portion of the object can be formed from a first material in accordance with any of the direct fabrication methods herein, and then a second portion of the object can be formed from a second material in accordance with methods herein, and so on, until the entirety of the object has been formed.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 µm, or within a range from about 5 µm to about 50 µm, or within a range from about 20 µm to about 50 µm.

The direct fabrication techniques described herein can be used to produce appliances with substantially isotropic material properties, e.g., substantially the same or similar strengths along all directions. In some embodiments, the direct fabrication approaches herein permit production of an orthodontic appliance with a strength that varies by no more than about 25%, about 20%, about 15%, about 10%, about 5%, about 1%, or about 0.5% along all directions. Additionally, the direct fabrication approaches herein can be used to produce orthodontic appliances at a faster speed compared to other manufacturing techniques. In some embodiments, the direct fabrication approaches herein allow for production of an orthodontic appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated at the end of each build. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

In many embodiments, environmental variables (e.g., temperature, humidity, Sunlight or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

Once appliances (e.g., aligners) are directly fabricated, they may be inspected using the systems and/or methods described herein above.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled rapid prototyping such as 3D printing, etc.). The computer-based methods presented herein can improve the accuracy, flexibility, and convenience of appliance fabrication.

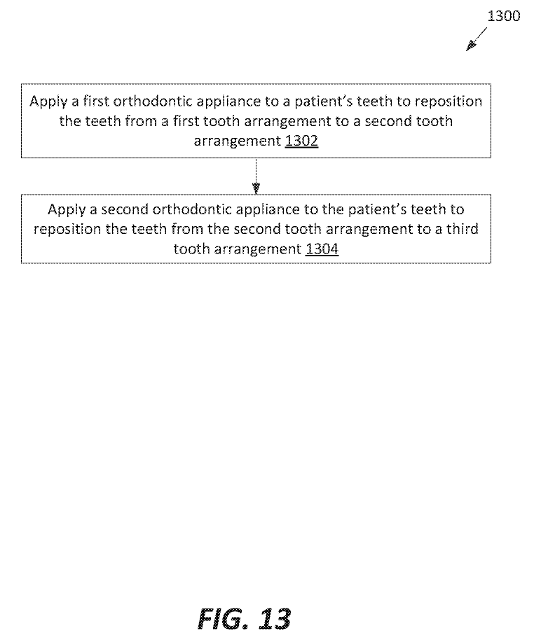

FIG. 13 illustrates a method 1300 of orthodontic treatment using a plurality of appliances, in accordance with embodiments. The method 1300 can be practiced using any of the appliances or appliance sets described herein. In block 1302, a first orthodontic appliance is applied to a patient’s teeth in order to reposition the teeth from a first tooth arrangement to a second tooth arrangement. In block 1304, a second orthodontic appliance is applied to the patient’s teeth in order to reposition the teeth from the second tooth arrangement to a third tooth arrangement. The method 1300 can be repeated as necessary using any suitable number and combination of sequential appliances in order to incrementally reposition the patient’s teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the "final." Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

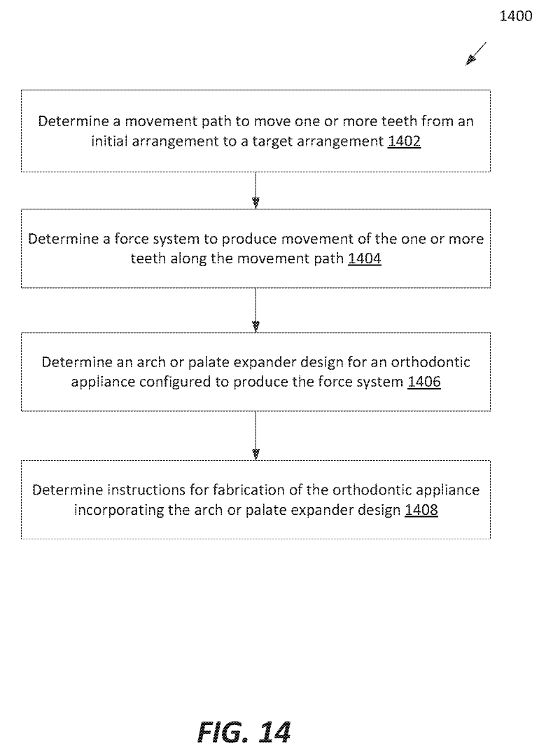

FIG. 14 illustrates a method 1400 for designing an orthodontic appliance to be produced by direct fabrication, in accordance with embodiments. The method 1400 can be applied to any embodiment of the orthodontic appliances described herein. Some or all of the blocks of the method 1400 can be performed by any suitable data processing system or device, e.g., one or more processors configured with suitable instructions.

In block 1402, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1404, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient’s mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient’s age—for example, young juvenile patients will typically require lower forces to expand the suture than older patients, as the suture has not yet fully formed.

In block 1406, an orthodontic appliance configured to produce the force system is determined. Determination of the orthodontic appliance, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA(Abaqus) software products from Dassault Systèmes of Waltham, MA.

Optionally, one or more orthodontic appliances can be selected for testing or force modeling. As noted above, a desired tooth movement, as well as a force system required or desired for eliciting the desired tooth movement, can be identified. Using the simulation environment, a candidate orthodontic appliance can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1408, instructions for fabrication of the orthodontic appliance incorporating the orthodontic appliance are generated. The instructions can be configured to control a fabrication system or device in order to produce the orthodontic appliance with the specified orthodontic appliance. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Method 1400 may comprise additional blocks: 1) The upper arch and palate of the patient is scanned intraorally to generate three dimensional data of the palate and upper arch; 2) The three dimensional shape profile of the appliance is determined to provide a gap and teeth engagement structures as described herein.

Although the above blocks show a method 1400 of designing an orthodontic appliance in accordance with some embodiments, a person of ordinary skill in the art will recognize some variations based on the teaching described herein. Some of the blocks may comprise sub-blocks. Some of the blocks may be repeated as often as desired. One or more blocks of the method 1400 may be performed with any suitable fabrication system or device, such as the embodiments described herein. Some of the blocks may be optional, and the order of the blocks can be varied as desired.

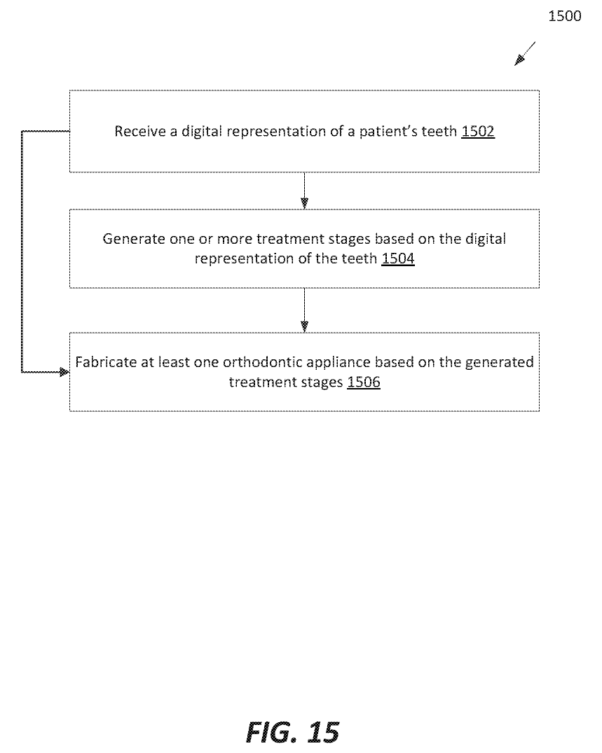

FIG. 15 illustrates a method 1500 for digitally planning an orthodontic treatment and/or design or fabrication of an appliance, in accordance with embodiments. The method 1500 can be applied to any of the treatment procedures described herein and can be performed by any suitable data processing system.

In block 1510, a digital representation of a patient’s teeth is received. The digital representation can include surface topography data for the patient’s intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1502, one or more treatment stages are generated based on the digital representation of the teeth. The treatment stages can be incremental repositioning stages of an orthodontic treatment procedure designed to move one or more of the patient’s teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1504, at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. Design and/or fabrication of an orthodontic appliance, and perhaps a particular orthodontic treatment, may include use of a representation of the patient’s teeth (e.g., receive a digital representation of the patient’s teeth), followed by design and/or fabrication of an orthodontic appliance based on a representation of the patient’s teeth in the arrangement represented by the received representation.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ± 10%.

Although the operations of the methods herein are shown and described in a particular order, the order of operations of each method may be altered so that certain operations may be performed in an inverse order or so that certain operation may be performed, at least in part, concurrently with other operations. In another embodiment, instructions or sub-operations of distinct operations may be in an intermittent and/or alternating manner. In one embodiment, multiple metal bonding operations are performed as a single step.

A few illustrative example implementations follow.

A first example implementation is directed to a defect detection system of transparent three-dimensional (3D) objects. The defect detection system comprises a transparent platform configured to support a transparent 3D object. The defect detection system comprises a plurality of light sources disposed beneath the transparent platform to illuminate the transparent 3D object through the transparent platform. The defect detection system comprises a plurality of cameras disposed about the transparent platform above a plane of the transparent platform and angled relative to the transparent platform, the plurality of cameras configured to generate a plurality of images of the transparent 3D object from a plurality of directions while the transparent 3D object is illuminated by one or more of the plurality of light sources, wherein each image of the plurality of images depicts a distinct region or view of the transparent 3D object. The defect detection system comprises a computing device configured to process the plurality of images to determine whether the transparent 3D object comprises a defect and output an indication of whether the transparent 3D object comprises a defect.

A second example implementation may extend the first example implementation. In the second example implementation, the plurality of images are processed using a trained artificial intelligence (AI) model, wherein an output of the trained AI model comprises a probability that the transparent 3D object comprises a defect.

A third example implementation may extend any of the first through second example implementations. In the third example implementation, the plurality of images comprises a set of images that are captured simultaneously, each image of the set of images captured by a different camera of the plurality of cameras.

A fourth example implementation may extend any of the first through third example implementations. In the fourth example implementation, the defect detection system further comprises an additional light source having an axis that is approximately normal to the transparent platform. The defect detection system further comprises an additional camera disposed above the transparent platform and having an imaging axis that is approximately normal to the transparent platform, the additional camera configured to capture an additional image during illumination of the transparent 3D object by the additional light source. In the fourth example implementation, the computing device is further configured to process the additional image to a) determine a part number of the transparent 3D object and b) determine whether the transparent 3D object comprises a defect.

A fifth example implementation may extend any of the first through fourth example implementations. In the fifth example implementation, the defect detection system further comprises spectral filters for each camera of the plurality of cameras, wherein the spectral filters are configured to filter out light that is outside of a wavelength range output by the plurality of light sources.

A sixth example implementation may extend the fifth example implementation. In the sixth example implementation, the wavelength range corresponds to at least one of infrared or near-infrared light.

A seventh example implementation may extend any of the fifth through sixth example implementations. In the seventh example implementation, the wavelength range is 820-930 nm.

An eighth example implementation may extend any of the first through seventh example implementations. In the eighth example implementation, the plurality of cameras comprises a plurality of side view cameras, wherein each side view camera of the plurality of side view cameras comprises a lens having a focal plane, an image sensor having an image plane, and a tilt shift adapter that causes the focal plane to have an angle relative to the image plane.

A ninth example implementation may extend the eighth example implementation. In the ninth example implementation, the plurality of side view cameras have a first angle relative to the transparent platform, and wherein the tilt shift adapter causes a second angle between the focal plane and the image plane that is a function of the first angle, wherein the tilt shift adapter causes an increase in a depth of field of the side view camera.

A tenth example implementation may extend any of the first through ninth example implementations. In the tenth example implementation, the transparent platform comprises a feature pattern in a circular configuration about a center of the transparent platform, wherein the feature pattern is configured to encircle the transparent 3D object.

An eleventh example implementation may extend the tenth example implementation. In the eleventh example implementation, the computing device is further configured to determine at least one of a position or an orientation of the transparent 3D object on the transparent platform based on identification of the feature pattern in the plurality of images.

A twelfth example implementation may extend the eleventh example implementation. In the twelfth example implementation, the defect detection system further comprises a robot arm configured to pick up the transparent 3D object using at least one of the determined orientation or the determined position of the transparent 3D object on the transparent platform.

A thirteenth example implementation may extend any of the tenth through twelfth example implementations. In the thirteenth example implementation, the computing device is further configured to perform configuration based on detection of the feature pattern in images captured by the plurality of cameras and geometric properties of the defect detection system.

A fourteenth example implementation may extend any of the tenth through thirteenth example implementations. In the fourteenth example implementation, the plurality of cameras are configured such that the feature pattern encircles approximately 90% of an area of the plurality of images.

A fifteenth example implementation may extend any of the first through fourteenth example implementations. In the fifteenth example implementation, the defect detection system is configured such that light refracted by the transparent 3D object causes a surface of the transparent 3D object to be visible in the plurality of images.

A sixteenth example implementation may extend any of the first through fifteenth example implementations. In the sixteenth example implementation, the defect detection system further comprises one or more matte white plates configured to direct light output by the plurality of light sources through the transparent 3D object and towards the plurality of cameras. The defect detection system further comprises one or more matte black plates disposed around the one or more matte white plates and configured to absorb light output by the plurality of light sources.

A seventeenth example implementation may extend the sixteenth example implementation. In the seventeenth example implementation, the defect detection system further comprises a plurality of light curtains disposed between light sources of the plurality of light sources and configured to block light between the light sources.

An eighteenth example implementation may extend any of the first through seventeenth example implementations. In the eighteenth example implementation, the computing device is further configured to determine a digital file associated with the transparent 3D object. The computing device is further configured to determine a first silhouette associated with the transparent 3D object from the digital file. The computing device is further configured to determine a second silhouette of the transparent 3D object from the plurality of images. The computing device is further configured to make a comparison between the first silhouette and the second silhouette. The computing device is further configured to determine a difference metric between the first silhouette and the second silhouette based on the comparison. The computing device is further configured to determine whether the difference metric exceeds a difference threshold. The computing device is further configured to determine that the transparent 3D printed object comprises a defect responsive to determining that the difference metric exceeds the difference threshold.

A nineteenth example implementation may extend any of the first through eighteenth example implementations. In the nineteenth example implementation, the computing device is further configured to perform the following for each image of the plurality of images: perform edge detection on the image to determine a boundary of the transparent 3D object in the image; select a set of points on the boundary; determine an area of interest using the set of points, wherein the area of interest comprises a first region of the image that depicts the transparent 3D object within the boundary; and crop the image to exclude a second region of the image that is outside of the area of interest, wherein the cropped image is processed by the computing device using a trained artificial intelligence (AI) model to identify defects.

A twentieth example implementation may extend any of the first through nineteenth example implementations. In the twentieth example implementation, the plurality of light sources are configured to provide a uniform luminance distribution during generation of the plurality of images.

A twenty-first example implementation may extend any of the first through twentieth example implementations. In the twenty-first example implementation, the defect detection system further comprises a plurality of light scattering plates, each light scattering plate of the plurality of light scattering plates positioned proximate to a light source of the plurality of light sources and configured to scatter light from the light source proximate to the light scattering plate.

A twenty-second example implementation is directed to a method of performing automated quality control for a transparent three-dimensional (3D) object. The method comprises providing illumination of the transparent 3D object using a plurality of light sources. The method comprises simultaneously generating a plurality of images of the transparent 3D object using a plurality of cameras, wherein each image of the plurality of images depicts a distinct region or view of the transparent 3D object. The method comprises processing the plurality of images by a computing device to identify defects of the transparent 3D object. The method comprises determining, by the computing device and without user input, whether the transparent 3D object comprises one or more defects based on a result of the processing.

A twenty-third example implementation may extend the twenty-second example implementation. In the twenty-third example implementation, the transparent 3D object comprises a polymeric orthodontic aligner for a patient at a treatment stage of an orthodontic treatment plan.

A twenty-fourth example implementation may extend any of the twenty-second through twenty-third example implementations. In the twenty-fourth example implementation, the method further comprises performing the following for each image of the plurality of images: performing edge detection on the image to determine a boundary of the transparent 3D printed object in the image; selecting a set of points on the boundary; determining an area of interest using the set of points, wherein the area of interest comprises a first region of the image that depicts the transparent 3D object within the boundary; and cropping the image to exclude a second region of the image that is outside of the area of interest, wherein the cropped image is processed by the computing device using an artificial intelligence (AI) model.

A twenty-fifth example implementation may extend any of the twenty-second through twenty-fourth example implementations. In the twenty-fifth example implementation, the plurality of images are processed using an artificial intelligence (AI) model, wherein an output of the AI model further comprises an indication of a severity of a detected defect.

A twenty-sixth example implementation may extend any of the twenty-second through twenty-fifth example implementations. In the twenty-sixth example implementation, the transparent 3D object is disposed on a transparent platform, wherein the plurality of light sources are disposed beneath the transparent platform and illuminate the transparent 3D object through the transparent platform, and wherein the plurality of cameras are disposed about the transparent platform above a plane of the transparent platform and angled relative to the transparent platform.

A twenty-seventh example implementation may extend the twenty-sixth example implementation. In the twenty-seventh example implementation, the method further comprises illuminating the transparent 3D object using an additional light source having an axis that is approximately normal to the transparent platform. The method further comprises capturing an additional image of the transparent 3D object using an additional camera disposed above the transparent platform and having an imaging axis that is approximately normal to the transparent platform during illumination of the transparent 3D object by the additional light source. The method further comprises processing the additional image to a) determine a part number of the transparent 3D object and b) determine whether the transparent 3D object comprises a defect.

A twenty-eighth example implementation may extend any of the twenty-second through twenty-seventh example implementations. In the twenty-eighth example implementation, the plurality of images are processed using a trained artificial intelligence (AI) model, wherein an output of the trained AI model comprises a probability that the transparent 3D object comprises a defect.

A twenty-ninth example implementation may extend any of the twenty-second through twenty-eighth example implementations. In the twenty-ninth example implementation, the method further comprises filtering light reaching the plurality of cameras using spectral filters for each camera of the plurality of cameras, wherein the spectral filters are configured to filter out light that is outside of a wavelength range output by the plurality of light sources.

A thirtieth example implementation may extend the twenty-ninth example implementation. In the thirtieth example implementation, the wavelength range corresponds to at least one of infrared or near-infrared light.

A thirty-first example implementation may extend any of the twenty-ninth through thirtieth example implementations. In the thirty-first example implementation, the wavelength range is 820-930 nm.

A thirty-second example implementation may extend any of the twenty-second through thirty-first example implementations. In the thirty-second example implementation, the plurality of cameras comprises a plurality of side view cameras, wherein each side view camera of the plurality of side view cameras comprises a lens having a focal plane, an image sensor having an image plane, and a tilt shift adapter that causes the focal plane to have an angle relative to the image plane.

A thirty-third example implementation may extend the thirty-second example implementation. In the thirty-third example implementation, the plurality of side view cameras have a first angle relative to a transparent platform that supports the transparent 3D object, and wherein the tilt shift adapter causes a second angle between the focal plane and the image plane that is a function of the first angle, wherein the tilt shift adapter causes an increase in a depth of field of the side view camera.

A thirty-fourth example implementation may extend any of the twenty-second through thirty-third example implementations. In the thirty-fourth example implementation, the transparent 3D object is disposed on a transparent platform comprising a dot pattern in a circular configuration about a center of the transparent platform. The method further comprises determining at least one of a position or an orientation of the transparent 3D object on the transparent platform based on identification of the dot pattern in the plurality of images.

A thirty-fifth example implementation may extend the thirty-fourth example implementation. In the thirty-fifth example implementation, the method further comprises picking up the transparent 3D object using a robot arm based on at least one of the determined orientation or the determined position of the transparent 3D object on the transparent platform.

A thirty-sixth example implementation may extend any of the thirty-fourth through thirty-fifth example implementations. In the thirty-sixth example implementation, the method further comprises configuring a defect detection system based on detection of the dot pattern in images captured by the plurality of cameras and geometric properties of the defect detection system.

A thirty-seventh example implementation may extend any of the thirty-fourth through thirty-sixth example implementations. In the thirty-seventh example implementation, the plurality of cameras are configured such that the dot pattern encircles approximately 90% of an area of the plurality of images.

A thirty-eighth example implementation may extend any of the twenty-second through thirty-seventh example implementations. In the thirty-eighth example implementation, light refracted by the transparent 3D object causes a surface of the transparent 3D object to be visible in the plurality of images.

A thirty-ninth example implementation may extend any of the twenty-second through thirty-eighth example implementations. In the thirty-ninth example implementation, the method further comprises determining a digital file associated with the transparent 3D object. The method further comprises determining a first silhouette associated with the transparent 3D object from the digital file. The method further comprises determining a second silhouette of the transparent 3D object from the plurality of images. The method further comprises making a comparison between the first silhouette and the second silhouette. The method further comprises determining a difference metric between the first silhouette and the second silhouette based on the comparison. The method further comprises determining whether the difference metric exceeds a difference threshold. The method further comprises determining that the transparent 3D object comprises a defect responsive to determining that the difference metric exceeds the difference threshold.

A fortieth example implementation may extend any of the twenty-second through thirty-ninth example implementations. In the fortieth example implementation, the method further comprises performing edge detection on an image of the plurality of images to determine a boundary of the transparent 3D object in the image. The method further comprises selecting a set of points on the boundary. The method further comprises determining an area of interest using the set of points, wherein the area of interest comprises a first region of the image that depicts the transparent 3D object within the boundary. The method further comprises cropping the image to exclude a second region of the image that is outside of the area of interest, wherein the cropped image is processed by the computing device using a trained artificial intelligence (AI) model to identify defects.

A forty-first example implementation may extend any of the twenty-second through fortieth example implementations. In the forty-first example implementation, the method further comprises fabricating the transparent object based on a digital file associated with the transparent 3D object prior to performing automated quality control.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A defect detection system of transparent three-dimensional (3D) objects, comprising:
a transparent platform configured to support a transparent 3D object;
a plurality of light sources disposed beneath the transparent platform to illuminate the transparent 3D object through the transparent platform;
a plurality of cameras disposed about the transparent platform above a plane of the transparent platform and angled relative to the transparent platform, the plurality of cameras configured to generate a plurality of images of the transparent 3D object from a plurality of directions while the transparent 3D object is illuminated by one or more of the plurality of light sources, wherein each image of the plurality of images depicts a distinct region or view of the transparent 3D object; and
a computing device configured to:
process the plurality of images to determine whether the transparent 3D object comprises a defect; and
output an indication of whether the transparent 3D object comprises a defect.

2. The defect detection system of claim 1, wherein the plurality of images are processed using a trained artificial intelligence (AI) model, wherein an output of the trained AI model comprises a probability that the transparent 3D object comprises a defect.

3. The defect detection system of claim 1, wherein the plurality of images comprises a set of images that are captured simultaneously, each image of the set of images captured by a different camera of the plurality of cameras.

4. The defect detection system of claim 1, further comprising:
an additional light source having an axis that is approximately normal to the transparent platform; and
an additional camera disposed above the transparent platform and having an imaging axis that is approximately normal to the transparent platform, the additional camera configured to capture an additional image during illumination of the transparent 3D object by the additional light source;
wherein the computing device is further configured to:
process the additional image to a) determine a part number of the transparent 3D object and b) determine whether the transparent 3D object comprises a defect.

5. The defect detection system of claim 1, further comprising:
spectral filters for each camera of the plurality of cameras, wherein the spectral filters are configured to filter out light that is outside of a wavelength range output by the plurality of light sources.

6. The defect detection system of claim 5, wherein the wavelength range corresponds to at least one of infrared or near-infrared light.

7. The defect detection system of claim 5, wherein the wavelength range is 820-930 nm.

8. The defect detection system of claim 1, wherein the plurality of cameras comprises a plurality of side view cameras, wherein each side view camera of the plurality of side view cameras comprises a lens having a focal plane, an image sensor having an image plane, and a tilt shift adapter that causes the focal plane to have an angle relative to the image plane.

9. The defect detection system of claim 8, wherein the plurality of side view cameras have a first angle relative to the transparent platform, and wherein the tilt shift adapter causes a second angle between the focal plane and the image plane that is a function of the first angle, wherein the tilt shift adapter causes an increase in a depth of field of the side view camera.

10. The defect detection system of claim 1, wherein the transparent platform comprises a feature pattern in a circular configuration about a center of the transparent platform, wherein the feature pattern is configured to encircle the transparent 3D object.

11. The defect detection system of claim 10, wherein the computing device is further configured to:
determine at least one of a position or an orientation of the transparent 3D object on the transparent platform based on identification of the feature pattern in the plurality of images.

12. The defect detection system of claim 11, further comprising:
a robot arm configured to pick up the transparent 3D object using at least one of the determined orientation or the determined position of the transparent 3D object on the transparent platform.

13. The defect detection system of claim 10, wherein the computing device is further configured to perform configuration based on detection of the feature pattern in images captured by the plurality of cameras and geometric properties of the defect detection system.

14. The defect detection system of claim 10, wherein the plurality of cameras are configured such that the feature pattern encircles approximately 90% of an area of the plurality of images.

15. The defect detection system of claim 1, wherein the defect detection system is configured such that light refracted by the transparent 3D object causes a surface of the transparent 3D object to be visible in the plurality of images.

16. The defect detection system of claim 1, further comprising:
one or more matte white plates configured to direct light output by the plurality of light sources through the transparent 3D object and towards the plurality of cameras; and
one or more matte black plates disposed around the one or more matte white plates and configured to absorb light output by the plurality of light sources.

17. The defect detection system of claim 16, further comprising:
a plurality of light curtains disposed between light sources of the plurality of light sources and configured to block light between the light sources.

18. The defect detection system of claim 1, wherein the computing device is further configured to:
determine a digital file associated with the transparent 3D object;
determine a first silhouette associated with the transparent 3D object from the digital file;
determine a second silhouette of the transparent 3D object from the plurality of images;
make a comparison between the first silhouette and the second silhouette;
determine a difference metric between the first silhouette and the second silhouette based on the comparison;
determine whether the difference metric exceeds a difference threshold; and
determine that the transparent 3D printed object comprises a defect responsive to determining that the difference metric exceeds the difference threshold.

19. The defect detection system of claim 1, wherein the computing device is further configured to perform the following for each image of the plurality of images:
perform edge detection on the image to determine a boundary of the transparent 3D object in the image;
select a set of points on the boundary;
determine an area of interest using the set of points, wherein the area of interest comprises a first region of the image that depicts the transparent 3D object within the boundary; and
crop the image to exclude a second region of the image that is outside of the area of interest, wherein the cropped image is processed by the computing device using a trained artificial intelligence (AI) model to identify defects.

20. The defect detection system of claim 1, wherein the plurality of light sources are configured to provide a uniform luminance distribution during generation of the plurality of images.

21. The defect detection system of claim 1, further comprising:
a plurality of light scattering plates, each light scattering plate of the plurality of light scattering plates positioned proximate to a light source of the plurality of light sources and configured to scatter light from the light source proximate to the light scattering plate.
